(19) United States
(12) Patent Application Publication
(10) Pub. No.: US 2019/0036648 A1
(43) Pub. Date: Jan. 31, 2019

(54) DISTRIBUTED SECURE DATA STORAGE AND TRANSMISSION OF STREAMING MEDIA CONTENT

(71) Applicant: Datomia Research Labs OU, Tallinn (EE)

(72) Inventors: David Yanovsky, Tallinn (EE); Teimuraz Namoradze, Tallinn (EE); Vera Dmitriyevna Miloslavskaya, Saint-Petersburg (RU)

(21) Appl. No.: 15/996,264

(22) Filed: Jun. 1, 2018

Related U.S. Application Data
(63) Continuation-in-part of application No. 15/304,457, filed on Oct. 14, 2016, now abandoned.
Application No. 15/304,457 is a continuation-in-part of application No. 15/460,119, filed on Mar. 15, 2017.
Application No. 15/460,119 is a continuation of application No. 15/460,093, filed on Mar. 15, 2017.
(60) Provisional application No. 62/053,255, filed on Sep. 22, 2014.
(60) Provisional application No. 61/992,286, filed on May 13, 2014.
(60) Provisional application No. 62/434,421, filed on Dec. 15, 2016.
(60) Provisional application No. 62/349,145, filed on Jun. 13, 2016.
(60) Provisional application No. 62/332,002, filed on May 5, 2016.
(60) Provisional application No. 62/308,223, filed on Mar. 15, 2016.

(51) Int. Cl. H04L 1/00; G06F 12/14; H03M 13/15; H03M 13/00; H03M 13/29; G06F 3/06; H04L 9/32; G06F 12/02; G06F 17/30; G06F 11/10; G06F 21/00; G06F 12/0846; H03M 13/13

(52) U.S. Cl. CPC H04L 1/0057; G06F 12/1466; G06F 11/1088; G06F 2212/1052; G06F 12/1408; H03M 13/616; H03M 13/2921; G06F 3/067; H04L 9/3226; G06F 2212/702; G06F 12/0253; G06F 17/30159; G06F 3/0619; G06F 11/1076; G06F 21/00; G06F 2212/282; G06F 12/0848; G06F 3/065; H03M 13/13; H03M 13/1515

(57) ABSTRACT

Disclosed is a method for the distributed storage and distribution of data. Original data is divided into fragments and erasure encoding is performed on it. The divided fragments are dispersedly stored on a plurality of storage mediums, preferably that are geographically remote from one another. When access to the data is requested, the fragments are transmitted through a network and reconstructed into the original data. In certain embodiments, the original data is media content which is steamed to a user from the distributed storage.

### CROSS REFERENCE TO RELATED APPLICATIONS

This application is a continuation-in-part of U.S. patent application Ser. No. 15/304,457, entitled “DISTRIBUTED SECURE DATA STORAGE AND TRANSMISSION OF STREAMING MEDIA CONTENT,” filed Oct. 14, 2016, which is a United States National Phase of International Patent Application No. PCT/US2015/030163, entitled “DISTRIBUTED SECURE DATA STORAGE AND TRANSMISSION OF STREAMING MEDIA CONTENT,” filed May 11, 2015, which claims priority to United States Provisional Patent Application No. 61/992,286, entitled “A Method for Data Storage,” filed May 13, 2014, and U.S. Provisional Patent Application No. 62/053,255, entitled “A Method for Media Streaming,” filed Sep. 22, 2014. This application is also a continuation-in-part of U.S. patent application Ser. No. 15/460,119, entitled “Distributed Storage System Data Management And Security,” filed Mar. 15, 2017, which is a continuation of U.S. Non-Provisional patent application Ser. No. 15/460,093, entitled “Distributed Storage System Data Management And Security,” filed Mar. 15, 2017, and U.S. patent application Ser. No. 15/460,119 claims priority to U.S. Provisional Patent Application No. 62/434,421, entitled “Cloud Based, Secure, Scalable, High Speed Data Storage,” filed Dec. 15, 2016, U.S. Provisional Patent Application No. 62/349,145, entitled “Cloud Based, Secure, Scalable, High Speed Data Storage,” filed Jun. 13, 2016, U.S. Provisional Patent Application No. 62/332,002, entitled “Cloud Based, Secure, Scalable, High Speed Data Storage,” filed May 5, 2016, and U.S. Provisional Patent Application No. 62/308,223, entitled “Cloud Based, Secure, Scalable, High Speed Data Storage,” filed Mar. 15, 2016, all of which are incorporated by reference, as if expressly set forth in their respective entireties herein.

This application further incorporates by reference, U.S. Provisional Patent Application No. 62/646,396, entitled “DISTRIBUTED STORAGE SYSTEM DATA MANAGEMENT AND SECURITY,” filed Mar. 22, 2018, as if expressly set forth in its respective entirety herein.

### FIELD OF THE DISCLOSURE

The subject matter of the present disclosure generally relates to secure data storage and transmission, and more particularly relates to distributed secure data storage and transmission for use in media streaming and other applications.

### BACKGROUND OF THE DISCLOSURE

The promise of cloud computing to revolutionize the landscape of information technology (IT) infrastructure is based upon the premise that both hardware and software resources previously maintained within a company's own data center or local network can be made available through a network of cloud servers hosted on the Internet by third parties, thereby alleviating the need for companies to own and manage their own elaborate IT infrastructures and data centers. However, in order to convince companies to transition their data storage and computing requirements to such third-party “cloud” server(s), the cloud servers need to provide a level of performance, data security, throughput and usability criteria that will satisfy customers' needs and security concerns. For example, storage resources remain a bottleneck to full scale adoption of cloud computing in the enterprise space. Current cloud-based storage resources can suffer from serious performance concerns, including dangerous security vulnerabilities, uncertainties in availability, and excessive costs. Cloud-based storage, or Storage as a Service (StAAS) must create a virtual “storage device” in the cloud which can compete with current in-house storage capacity found in the enterprise data center.

The present application addresses this in a system and method in which the broadcaster, who may be an individual using a portable computer device, provides viewers with the ability to launch supplemental content that has been curated by the broadcaster to the topics and information sources chosen by the broadcaster. As such, a more personal and deeper experience can be had by utilizing the present invention.

Current cloud-based storage solutions are most often based on conventional file storage (CIFS, NFS) technology, in which whole files and groups of files are stored in one physical server location. This approach fails to offer acceptable data transfer rates under typical communications conditions found on the Internet. Latency is poor, and the end-user or consumer perceives a performance wall in even the best designed cloud applications. In addition, transfer of large amounts of data can take an inordinate amount of time, making it impractical. For example, a 1 Tb data transfer through the cloud using current technologies could require weeks to complete.

Cloud storage, in which complete files are stored in a single location, also provides a tantalizing target for hackers interested in compromising sensitive company information. All the efforts put into design of security procedures in the enterprise data center can vanish with one determined hacker working over the Internet. It is therefore highly desirable to increase the security of cloud-based storage systems.

Cloud storage solutions are also highly vulnerable to “outages” that may result from disruptions of Internet communications between the enterprise client and its cloud storage server. These outages can be of varying duration, and can be lengthy, for example, in the event of a denial of service (DOS) attack. An enterprise can suffer significant harm if it is forced to cease operations during these outages.

Cloud storage solutions based on storage of whole files in one server location also make disaster recovery a potential pitfall if the server location is

compromised. If replication and backup are also handled in the same physical server location, the problem of failure and disaster recovery could pose a real danger of massive data loss to the enterprise.

Current technology cloud storage solutions require the storage overhead of complete replication and backup to ensure the safety of the stored enterprise data. In typical current cloud storage technology setups this can require up to 800% redundancy in stored data. This large amount of required data redundancy adds a tremendous overhead in costs to maintain the storage capacity in the cloud. The need for such redundancy not only increases cost, but also introduces new problems for data security. In addition, all this redundancy also brings with it performance decreases as cloud servers use replication constantly in all server data transactions.

As Internet connections have improved in their ability to handle high throughputs of data, media streaming has become a very popular way to provide media content, such as videos and music, in a way that reduces the risk of unscrupulous copying. Cloud storage plays an important role in many media content streaming schemes.

Typically, the media content resides on a company's web server. When requested by a user, the media content is streamed over the Internet in a steady stream of successive data segments that are received by the client in time to display the next segment of the media file, resulting in what appears to be seamless playback of the audio or video to the user.

Currently, media streaming technology is based upon the concept of transferring media files through web servers, in compressed form, as a segmented stream of data which is received by the client in time to play the next segment of the media file so as to provide continuous playback. In some cases, the rate of data transfer exceeds the rate at which the data is played, and the extra data is buffered for future use. If the rate of data transfer is slower than the rate of data playback, the presentation will stop while the client collects the data needed to play the next segment of the media. The advantages of streaming media technology are found in the fact that the client does not need to wait to download an entire large media file (e.g., a full length movie) and the fact that the on-demand download nature lends itself to process digital rights management (DRM) schemes that protect against unauthorized copying of the media content by the client.

Current media streaming technology stores a complete copy of the entire media file on a web or media server to which the client connects to receive the stream of data. Data losses during the transmission process can easily interrupt the transfer process and halt the playback of the media content on the client. To avoid such problems, the prior art technology often will place the same media file on multiple server nodes, and multiple data centers throughout the world, whether they be public or private, so the user can connect to a server node near them. While this is necessary to insure the steady data transfer rates needed in the face of data packet loss due to connectivity issues, deploying multiple copies of the same file on many servers throughout the world places a major burden on streaming media providers.

The subject matter of the present disclosure is directed to mitigating and/or overcoming one or more of the problems set forth above and to providing for a more secure data storage and transmission method, and more particularly to providing for a more secure data storage and transmission method for use in media streaming and other applications.

### BRIEF SUMMARY OF THE DISCLOSURE

Disclosed is a method and system for secure distributed data storage that is particularly suited to the needs of streaming media.

A particular data storage embodiment involves separating a media data file into multiple discrete pieces, erasure coding these discrete pieces, and dispersing those pieces among multiple storage units, wherein no one storage unit has sufficient data to reconstruct the data file. A map is generated, showing in which storage units each of the discrete pieces of the data file is stored. In particular, a unique identifier is assigned to each discrete piece and a map of the unique identifiers is used to facilitate the reassembly of the data files.

In another embodiment, the data storage technique disclosed herein involves separating a data file into slices, assigning a unique identifier to each slice, creating a map of the unique identifiers to facilitate reassembly, fragmenting of each slice into discrete slice fragments, erasure coding of the slice fragments, dispersing the fragments among multiple storage units wherein no storage unit has sufficient data to reconstruct the data file, and generating a map of which storage units house what fragments.

The goals of both data security and packet loss mitigation are remedied by the disclosed erasure coding process. First, data is coded into unrecognizable pieces, during the erasure coding process thereby providing a high degree of security. Second, the erasure coded data provides for error correction in the event a data loss. While erasure coding increases the amount of data, data losses that are less than the increase in data size can be accommodated, and recovered. Notably, the processed and erasure-coded data that is stored in accordance with preferred embodiments does not include any replications of the original data, thus strongly increasing security.

In one embodiment, a method for storing streaming media content includes separating a digital media content file into discrete pieces or fragments, erasure coding the discrete pieces and dispersing the discrete pieces among multiple storage units, wherein no one storage unit has sufficient data to reconstruct the media content. In a preferred embodiment, a map is generated that details in which storage unit each of the discrete pieces is stored. Unique identifiers are assigned to each discrete piece of the media content and a map of the unique identifiers is used to facilitate reassembly of the media content. For example, the map can be used by a client device to reconstruct the media file and allow playing of the media content on the client device, either in a browser or otherwise.

In another embodiment, a method of data storage includes the steps of separating a data file into slices, assigning unique identifiers to each slice, creating a map of the unique identifiers, fragmenting the slices into discrete pieces or fragments, erasure coding the discrete pieces, dispersing the discrete pieces among multiple storage units, wherein no storage unit has sufficient data to reconstruct the data file, and, generating a map showing in which storage units each of the discrete pieces is stored. Decoding is performed on a client device by using the maps to allow playback and/or further storage of a streamed media file.

### BRIEF DESCRIPTION OF THE DRAWINGS

The foregoing summary, preferred embodiments, and other aspects of the present disclosure will be best understood with reference to the following detailed description of specific embodiments, when read in conjunction with the accompanying drawings, in which:

FIG. 1 is a schematic diagram of three layers of an exemplary storage system.

FIG. 2 is a diagram showing the various stages of file processing according to an exemplary embodiment.

FIG. 3 is a chart outlining various steps undertaken during file processing according to an exemplary embodiment.

FIG. 4A is a diagram of a first section of file processing according to an exemplary embodiment.

FIG. 4B is a diagram of the erasure coding of file slices to produce slice fragments for dispersal according to an exemplary embodiment.

FIG. 5 is a detailed diagram of the upload process of a file to data storage nodes according to an exemplary embodiment.

FIG. 6 is a chart of the various detailed steps undertaken during a download process of data from data storage to a client, according to an exemplary embodiment.

FIG. 7A is a diagram of a client download request being made to the CSP, according to an exemplary embodiment.

FIG. 7B is a diagram of a request for slice fragments according to an exemplary embodiment.

FIG. 8 is a detailed diagram of the interaction between the CSP, FEDP and SNN during a file download process.

FIG. 9 is a diagram of a data garbage collection process according to an embodiment.

FIG. 10 is a schematic block diagram illustrating file processing and dispersal among storage nodes for further streaming.

FIG. 11 is a schematic block diagram illustrating selection of code parameters for erasure coding.

FIG. 12 is a schematic block diagram illustrating example implementation of assigning packages to storage nodes.

FIGS. 13 (A-C) illustrate possible distribution of amount of data among storage nodes.

FIG. 14 illustrated process of computation priorities for packages and their downloading.

FIG. 15 illustrates usage of sliding window approach for package downloading according to priorities.

FIG. 16 illustrates utilizing mesh network with network coding for data streaming.

Like reference numbers and designations in the various drawings indicate like elements.

### DETAILED DESCRIPTION

Disclosed, herein, is a cloud storage technology for streaming media files, which breaks up each data file into file slice fragments which are stored on a series of cloud servers, that are preferably dispersed among different geographical locations. In an embodiment, client enterprise media data is disassembled into file slice fragments using object storage technology. All the resulting file slice fragments are encrypted, and optimized for error correction using erasure coding, before dispersal to the series of cloud servers. This creates a virtual “data device” in the cloud. The servers used for data storage in the cloud can be selected by the client to optimize for both speed of data throughput and data security and reliability. For retrieval, the encrypted and dispersed file slice fragments are retrieved and rebuilt into the original file at the client's request. This dispersal approach creates a “virtual hard drive” device in which a media file is not stored in a single physical device, but is spread out among a series of physical devices in the cloud which each only contain encrypted “fragments” of the file. Access of the file for the purposes of moving, deleting, reading or editing the file is accomplished by reassembling the file fragments rapidly in real time. This approach provides numerous improvements in speed of data transfer and access, data security and data availability. It can also make use of existing hardware and software infrastructure and offers substantial cost reductions in the field of storage technology.

While the dispersed storage of data, including in particular streaming media data, on cloud servers is one particularly useful application, the same technology is applicable to configurations in which the data may be stored on multiple storage devices which may be connected by any possible communications technology such as LAN's or WAN's. The speed and security benefits of the disclosed technology could remain within the devices of an information technology (IT) data center, where the final storage devices are multiple physical hard disks or multiple virtual hard disks. An IT user may choose to use all the storage devices available throughout the company which are connected by a high speed LAN in which the disclosure's technology is implemented. The multiple storage devices may even be spread across multiple individual users in cyberspace, with files stored on multiple physical or virtual hard disks which are available in the network. In each case, the speed of data transfer and security of data storage in the system are greatly enhanced.

Uses for the disclosed subject matter include secondary data storage, for backup or disaster recovery purposes. The disclosed subject matter is also applicable to primary storage needs where the files are accessed without server-side processing. In certain embodiments, this includes storage of media content, including without limitation video or audio content that can be made available for streaming through the Internet.

Data Storage Advantages

The disclosed storage technology presents numerous advantages over existing systems. Among these advantages are the following:

A. Data Transfer Rates

Compared to existing cloud storage technology, the disclosed embodiments permit substantial improvements in the speed of data transfer under typical Internet communication conditions. Speeds of up to 300 mbps have been demonstrated, which would mean for example, that transfer of a 1 Tb file, which could take a month using some existing systems, can be completed in 10 hours. This speed improvement stems from several factors.

When reconstructing a file its attendant “pieces” are transferred from/to multiple servers in parallel, resulting in substantial throughput improvements. This can be likened to some of the popular download accelerator technologies in use today, which also open multiple channels to download pieces of a file, resulting in substantial boost in download rates. Latency bottlenecks that might occur in one of the transfer connections to one of the cloud servers do not stop the speedier transfers to the other servers which are operating under conditions of normal latency.

The inherent improvements in data security and reliability stemming from distributed storage eliminates the need for constant mirroring of data read/writes through replication, resulting in further speed improvements to throughput.

Typically, the most resource intensive processing of the data occurs at the server side on one or more very high performance servers in the cloud, which are optimized for speed and connectivity to both the cloud server storage sites and the client sites.

In particular, erasure coding in certain embodiments is performed at the server side, for example, as described further herein, on multiple data processing servers. These servers may be chosen to have high processing performance, since the erasure coding process is typically a central processing unit (CPU) intensive task. This results in improved performance as compared to erasure coding done at the client side, which may lack the hardware and software infrastructure to efficiently perform erasure coding, or on a single server. Moving such processing to an optimized group of servers decreases the load and performance requirements at the client side, compared to existing designs.

B. Data security

The disclosed “virtual device” storage offers significant improvements in terms of data security over previous designs. By breaking up each media file into many file slice fragments and dispersing the file slice fragments over many cloud storage locations, preferably at geographically dispersed locations, a hacker would find it extremely difficult to reassemble the file into its original form. In addition, the file slice fragments are all encrypted in certain embodiments, adding another layer of data security to confound a would-be hacker. A successful hack into one of the cloud storage locations will not give the hacker the ability to reassemble the full media file. This is a significant improvement in data security over previous designs.

In certain embodiments, the servers used for both processing and storage of file slice fragments may be shared by multiple clients, with no way for a hacker to identify from the data slices to which client they may belong. This makes it even more difficult for a hacker to compromise the security of file data stored using this technology. File slice fragments may be dispersed randomly to different cloud storage servers, further enhancing the security of the data storage. In certain embodiments, not even the client may know exactly the locations to which all the file slice fragments have been directly dispersed. Also, there is no one place where all the keys are stored to reassemble the file slice fragments and/or decrypt the file slice fragments. Lastly, as an additional enhancement to data security, a two dimensional model of metadata storage may be used, in which metadata needed to reconstruct the data is stored on both the client side and on remote cloud storage servers.

C. Data Availability

The disclosed “virtual device” storage also offers improvements in the availability of the data, compared to prior art storage technology. By splitting the file into multiple file slice fragments which are stored on a number of different cloud servers, communications problems between the client location and one of the physical cloud locations may be compensated by normal communications with and low latency at other data locations. The overall effect of having file fragments dispersed among multiple locations is to insulate the overall system from outages due to communications disruptions at one of the sites.

Preferably, the intermediate server processing nodes discussed below are all comprised of high performance processors and have low latencies. This results in high availability to the client for data transfers.

Preferably, the intermediate server processing nodes may be chosen dynamically in response to each client request to minimize latency with the client who requests their services. The client may also select from a list of cloud storage servers to be used to store the file slice fragments, and can optimize this list based on his geographical location, and the availability of these servers. This further maximizes data availability for each client at the time of each transfer request.

D. Data reliability

The disclosed “virtual device” storage also provides improvements over the prior art in the reliability of a cloud data storage system. Separation of each file into file slice fragments means that hardware or software failures, or errors at one of the physical cloud storage locations will not prevent access to the file, as would be the case if the entire file is stored in one physical location, as in certain previously existing systems. Further, the use of the erasure coding technology discussed herein insures high quality error correction capabilities in the system, enhancing both data security as well as reliability. The combination of file slice fragments and the erasure coding techniques used herein provides major advances to reliability to encourage enterprise adoption of cloud technology.

E. Use of Existing Cloud Infrastructure Resources

Elements of the disclosed subject matter may make use of existing cloud server infrastructures, with both public and private resources. Current cloud providers can be setup with their existing hardware and software infrastructure for use with the disclosed methodology. Most of the enhancements offered by the technology disclosed herein may therefore be available with minimal investment, as currently existing cloud resources can be used either without modification or with minimal modification.

F. Reduction of Infrastructure Cost

Certain embodiments require far less redundancy compared to existing cloud storage technology solutions. As mentioned above, previous storage systems can require as much as 500% additional storage devoted to mirroring and replication. The embodiments disclosed herein may operate successfully with only a 30% redundancy over the original file size because of their higher inherent reliability. Even with only 30% redundancy, higher levels of reliability over existing systems can be achieved. The reduced necessity for high redundancy results in lower costs for cloud storage capacity. With the exponential growth in enterprise data and storage needs seen year to year, this reduction of redundancy is an important factor in making a cloud solution economically viable for an enterprise as a complete replacement for its local data center.

As further disclosed herein, embodiments of the disclosed “virtual device” storage technology accomplish certain tasks: splitting of files into file slices and file slice fragments which will eventually be transferred to a predetermined number of cloud storage locations; creating maps of the file slices and file slice fragments which describe how the files were split, and at which cloud location a group of file slice fragments are stored, to allow for re-assembly of the file by the client; encrypting the file slices and file slice fragments to provide additional data security; adding erasure coding information to the pieces for error checking and recovery; and garbage collection of orphaned file slice fragments which were not properly written and disassembled or read and reassembled.

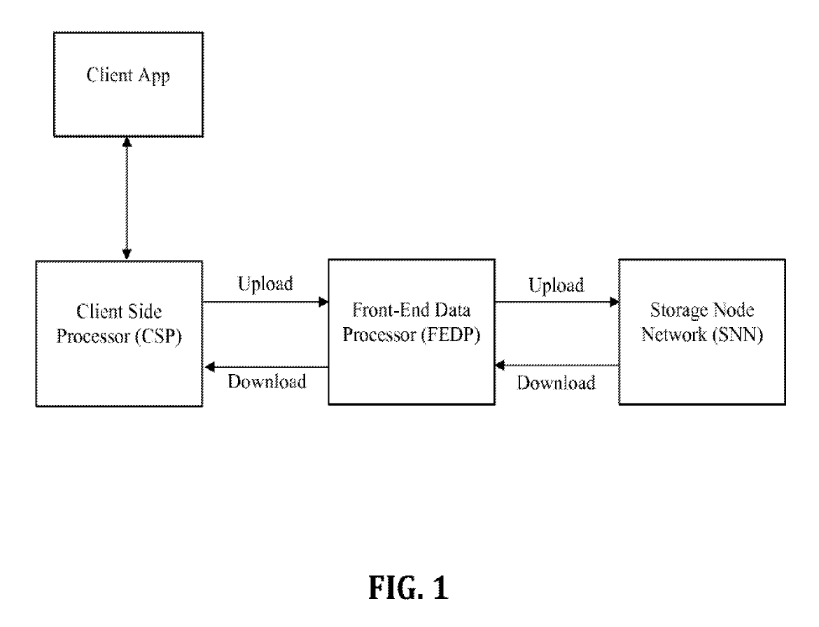

As illustrated in FIG. 1, the basic structure of an exemplary system embodiment may be visualized as including three layers. A first layer is the client-side processor (CSP) which may be located at the client's back office or data center. A client application (such as a web app running in a browser) may be used to access the CSP to both set application parameters and initiate uploads of files from the client's data center to the storage node network and downloads of files from the storage node network to the client's data center. In the Figures, “Slice” is generally used to refer to a file slice, and “atom” is generally used to refer a file slice fragment.

A second layer of the exemplary system includes front-end data processor (FEDP) which perform intermediate data processing. THE FEDP may be located at multiple dispersed locations in the cloud. Multiple FEDP servers may be available to each client, with each FEDP server providing high processing performance, and high availability connections to the client's location.

A third layer of an exemplary system embodiment is the storage nodes network (SNN). The SNN may include various cloud storage centers that may be operated by commercial cloud resource providers. The number and identity of the storage nodes in the SNN may be optionally selected by the client using his client application to optimize the latency and security of the storage configuration by choosing storage nodes that exhibit the best average latency and availability from the client's location.

FIG. 1 is a schematic diagram showing the interrelationships between the CSP, FEDP and SNN.

The basic functions performed by these three layers can be described as follows. The CSP can receive and initiate a request for upload of a file to the SNN from a client app. As a first step, it splits the file into a number of slices, each of a given size. The number and size of the slices may be varied via parameters available to the client app. Each slice may be encrypted with a client key, and assigned a unique identifier. The CSP will also produce a metadata file which maps the slices to allow for their reassembly into the original complete file. This metadata file may be stored at the client's data center and may also be encrypted and copied into the SNN. In an exemplary embodiment, the CSP may then send out the sliced files to the next layer, the front end data processor (FEDP), for further processing.

The FEDP may receive sliced files from the CSP and further process each slice. This processing may divide each slice into a series of file slice fragments. Erasure coding is performed to provide error correction, for example, in the event some data is lost during the transmission process. The erasure coding, as will be further described herein, will increase the size of each file slice fragment, to provide for error correction. The FEDP may also encrypt the file slice fragment using its own encryption key. The FEDP will create another metadata file which maps all of the file slice fragments back to their original slices, and records which storage nodes network (SNN) servers are to be used to store which file slice fragments. Once, this intermediate processing is performed, the FEDP sends groups of file slice fragments to their designated SNN servers in the cloud, and sends a copy of the metadata file it created to each SNN server.

At the third layer, the SNN servers will now host the processed file slice fragments in the cloud at normally available cloud hosting servers, waiting to receive a future request through the system for file download. The download process basically reverses the steps described above in the three processing layers, so as to reconstruct the original file or file slices at the CSP.

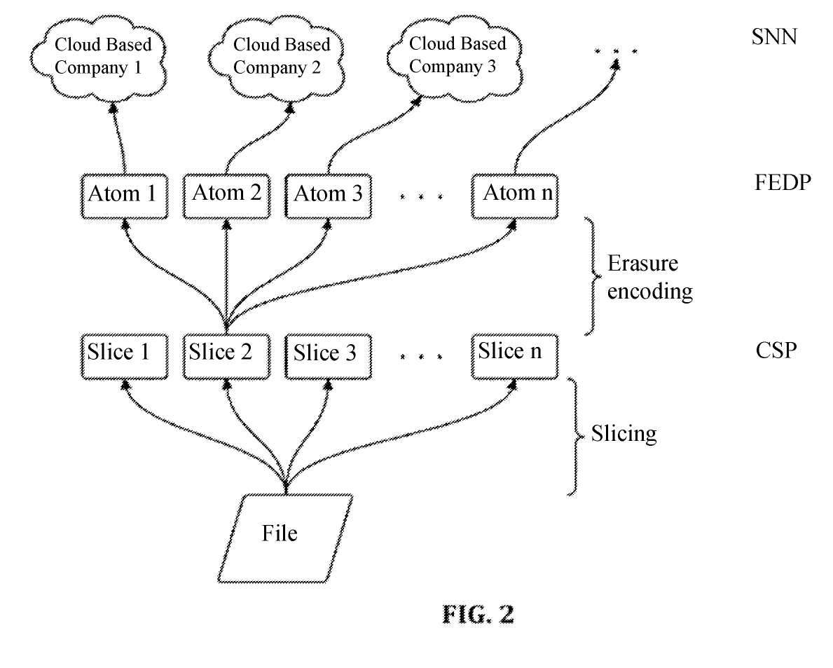

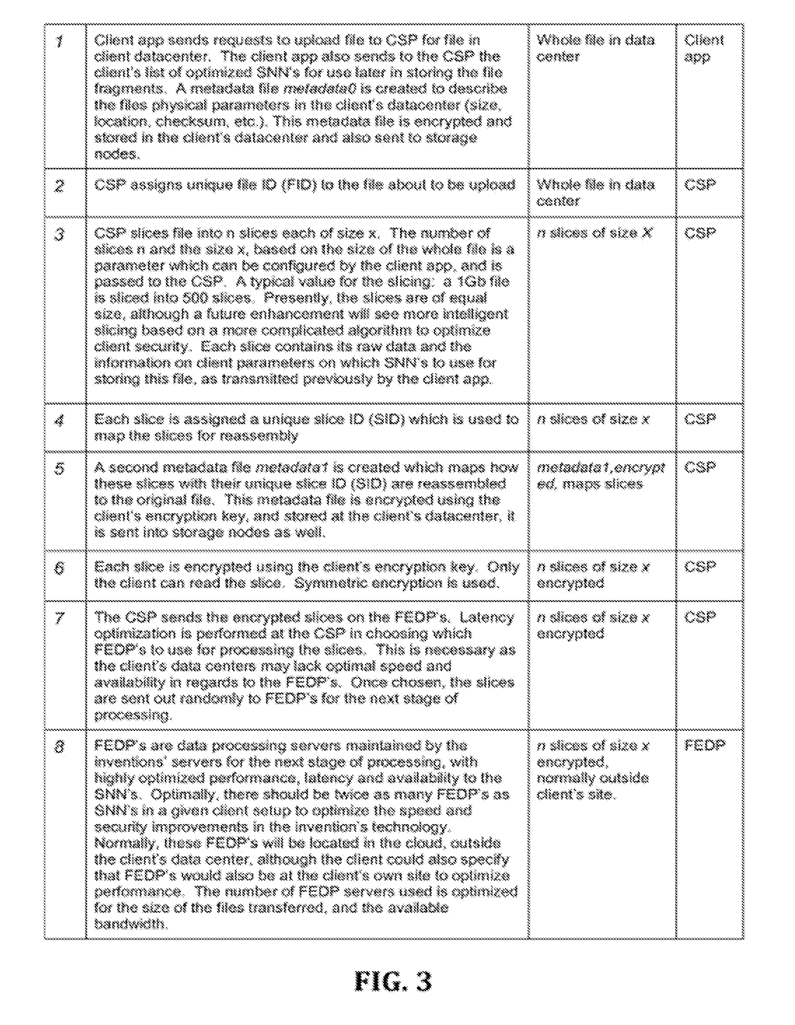

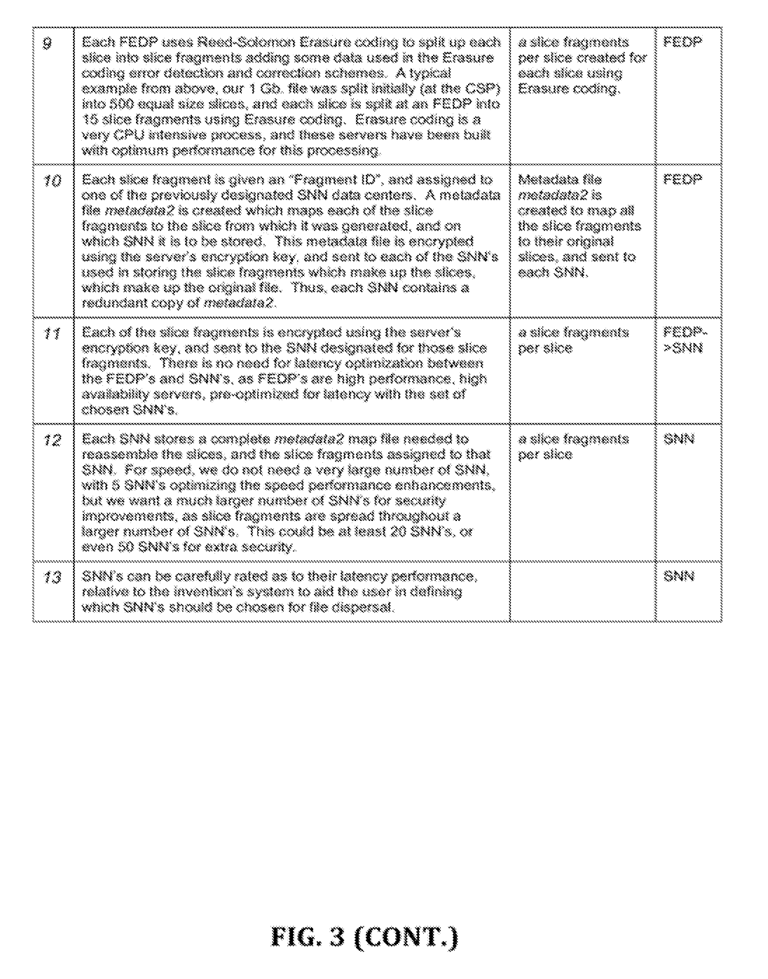

FIG. 2 illustrates the various stages of file processing discussed above for each of the CSP, FEDP and SNN during upload of a file to the SNN according to an exemplary embodiment. FIG. 3 is a chart of the detailed steps that may be included in a file upload process performed in accordance with an exemplary embodiment.

File Uploading

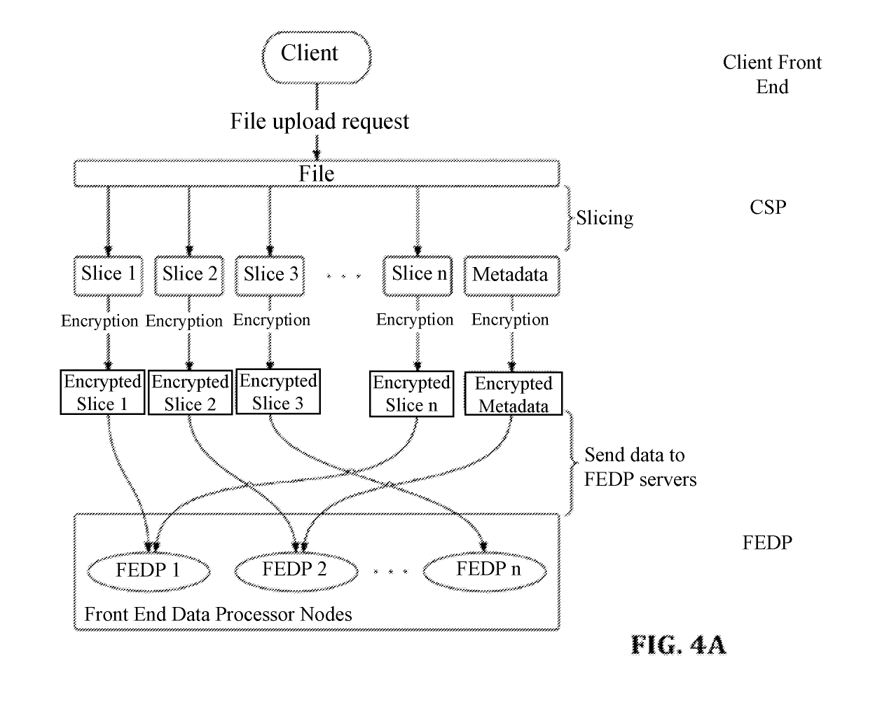

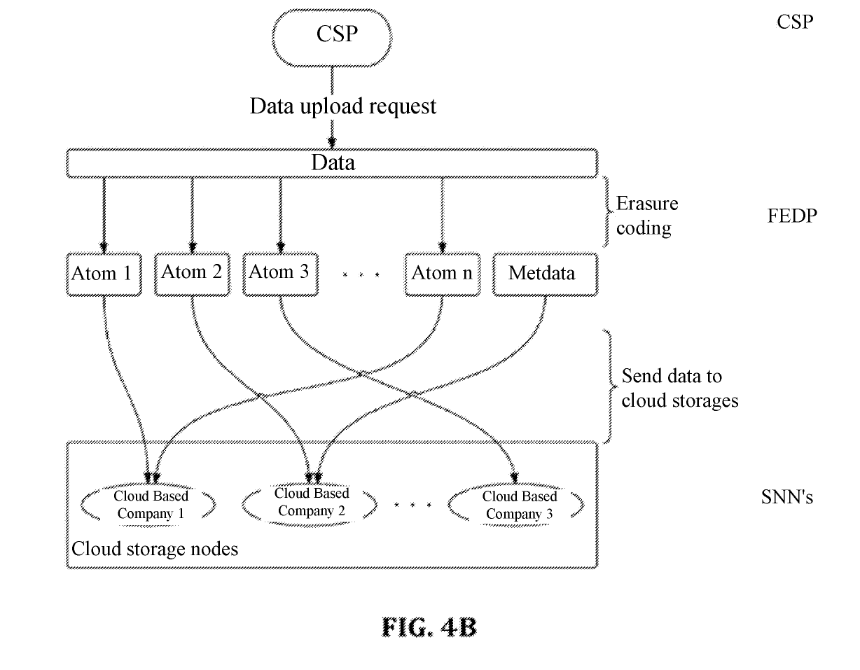

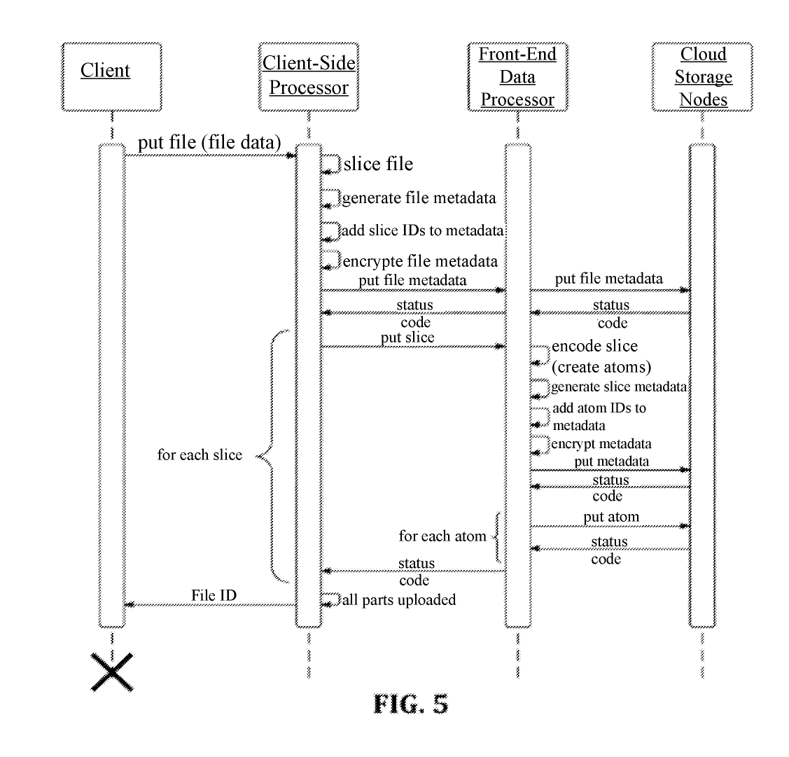

FIGS. 4A and 4B respectively show the two basic processing stages during the upload process of a file from the CSP to the FEDP and then to the SNN: processing at the CSP of a file into file slices, and processing at the FEDP of file slices to create file slice fragments for dispersal to the SNN's. FIG. 5 is another illustration of the upload process in step-by-step fashion, showing some of the intermediate steps.

File Downloading

The process of downloading a file which has been previously uploaded to the SNN involves a reversal of the steps used in the upload process. The slice fragments which are stored across many SNN's must be reassembled into file slices using a second metadata file which maps how slice fragments are reassembled into slices. This is done by the FEDP. The file slices so generated must be reassembled by the CSP into a complete file using the first metadata file which maps how the slices are reassembled into a whole file for delivery to the client's data center. The second metadata file is stored redundantly on each of the SNN's used to store the file, and the first metadata file is stored in the client's datacenter and on each SNN as well.

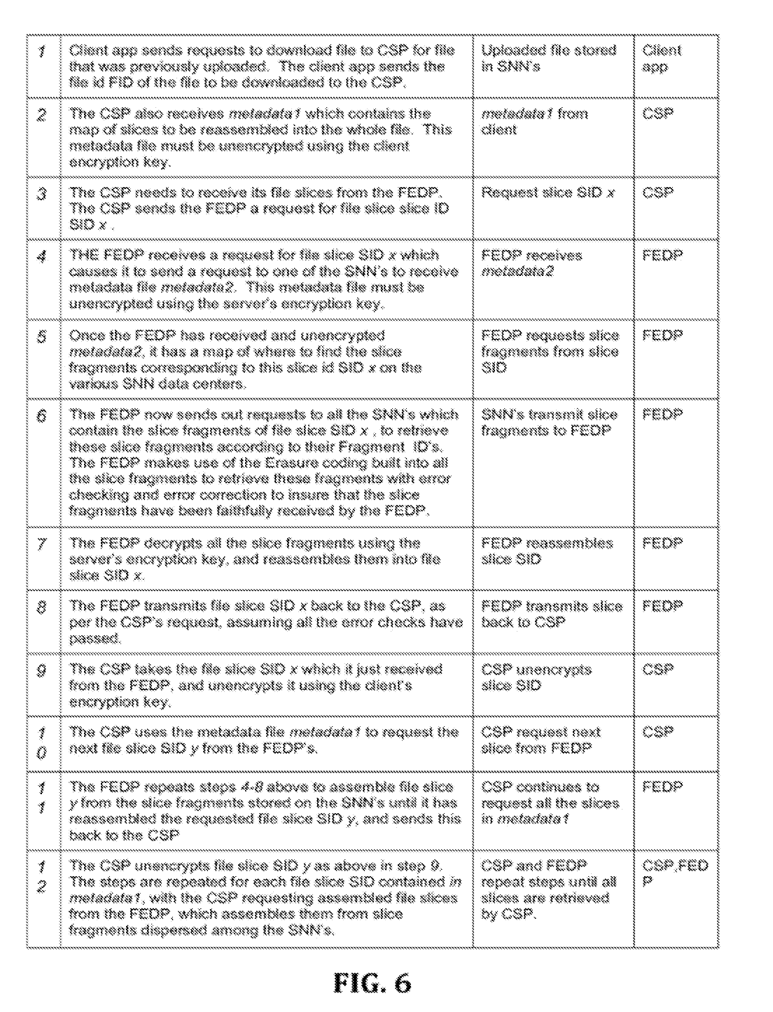

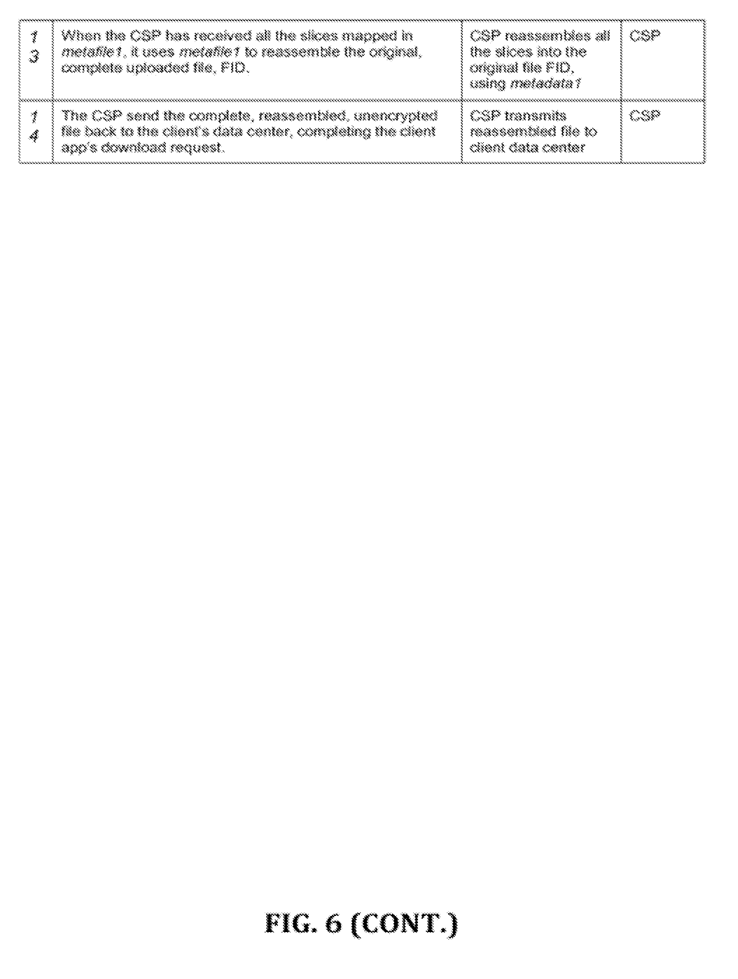

FIG. 6 is a chart of the detailed steps that may be involved in the download process.

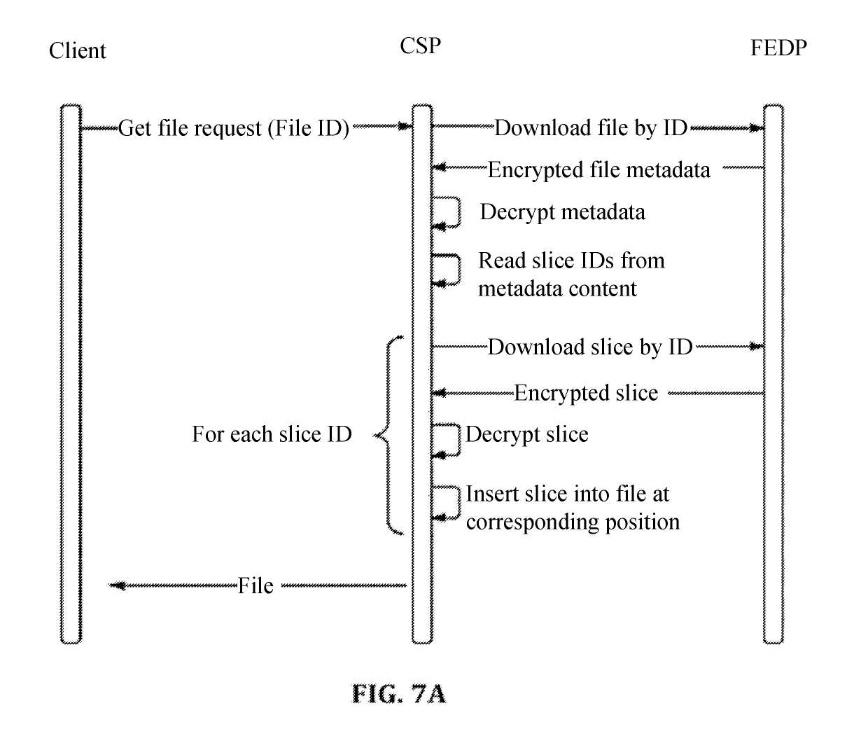

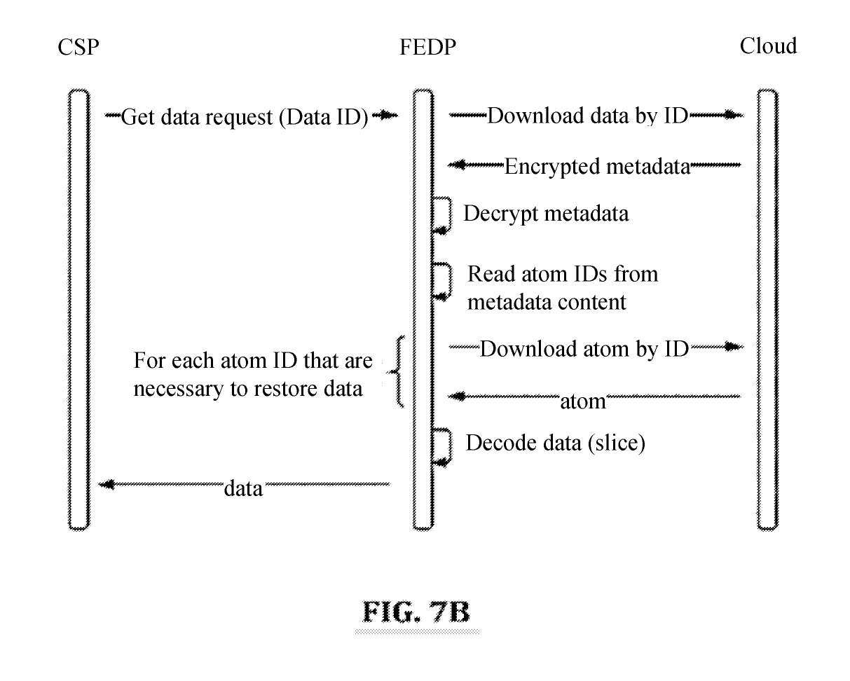

FIG. 7A shows the download process among the three layers, showing the requests made between the CSP and the FEDP, and the requests between the FEDP and the SNN. FIG. 7B illustrates the steps involved when the FEDP requests slice fragments from the SNN to reassemble a requested file slice using the second metadata file.

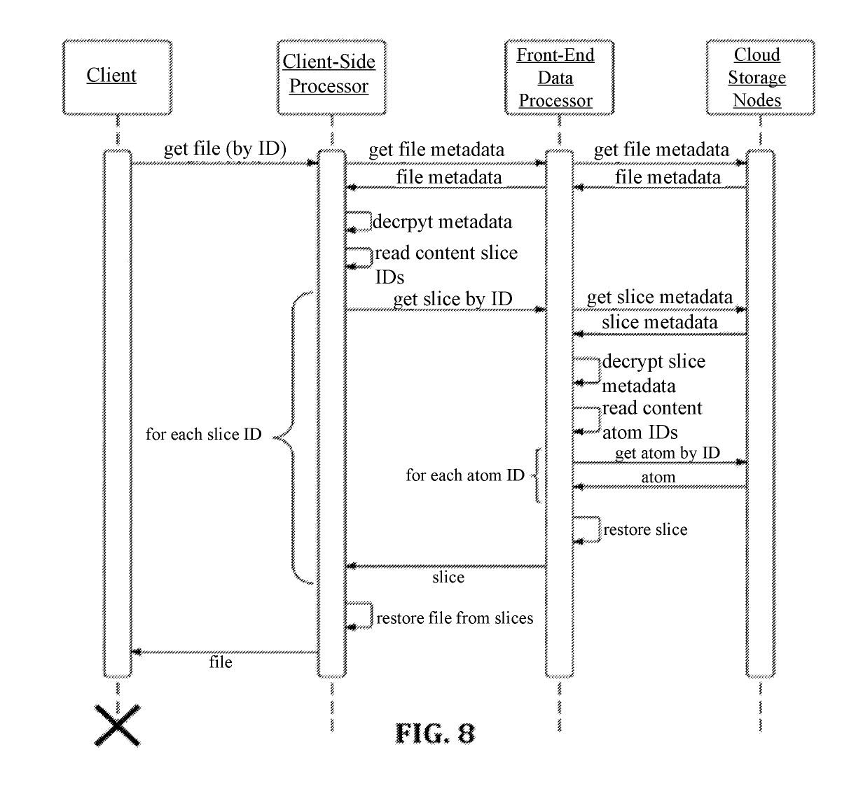

FIG. 8 illustrates the detailed steps of the interaction between CSP, FEDP and SNN during the download process.

Technology Optimizations

As discussed above, the disclosed method and system provides major improvements in both data throughput, data availability, data reliability and data security.

The multiple number of upload and download nodes used in the system will speed up both uploading and downloading. A further increase in throughput speed may be obtained by optimizing the latency between the CSP and the FEDP's, and choosing the FEDP's with the best current latency available. There is no need to optimize for latency between the FEDP's and the SNN's, as the FEDP's are set up as high performance, high availability servers which are designed to automatically minimize latency to the SNN's. The use of multiple nodes also decreases the performance hit seen if one particular server path is suffering from high latency.

The use of many storage nodes for storing file slice fragments greatly increases the security available in the storage of client data. The task of a hacker finding the necessary information to tap into all the disparate slice fragments at a large number of SNN's, and reassemble them into a usable file is very formidable.

The use of erasure coding for the dispersal of the slice fragments adds an extra layer of reliability through its inherent error checking/correction which allows the system to dispense with the need for multiple data replication, with it's inherent performance hits and security risks.

Additional Issues

One area, which remains very resource intensive, as mentioned before, is the erasure coding process, which is very CPU intensive. To address this issue, very high performance FEDP hardware insures that the CPUs (or virtual CPUs) used in these FEDP servers meet the performance needs of the system. In addition, the entire software package may be coded in “Go” language, including the FEDP servers. The native code objects generated by the “Go” language help to improve overall system performance, particularly in the FEDP servers, where erasure coding takes major CPU resources.

The client app may be any client agent capable of running on the client's operating system (OS) platforms. Optionally, a client app may be written in Javascript to run in browsers. This helps in making such client app available across a wide variety of physical devices.

The data storage techniques described above may be designed to use virtualized servers throughout. For example, 3 virtual servers in parallel could be used instead of one real hardware server to improve performance, and insure hardware independence. The current system is based on object storage technology, which treats the data as a mass to be referenced, independent of any particular file structure. The goal was to create a system, which can be transferred into block storage, to suit the current virtualization standards in data storage. The current object model can be easily mapped into block storage in the future.

In certain embodiments, error correction by way of erasure coding is done on the FEDP, using Reed-Solomon coding. A garbage collection system is also employed at the FEDP, in the event of incomplete reads and writes of the FEDP to/from the SNN's.

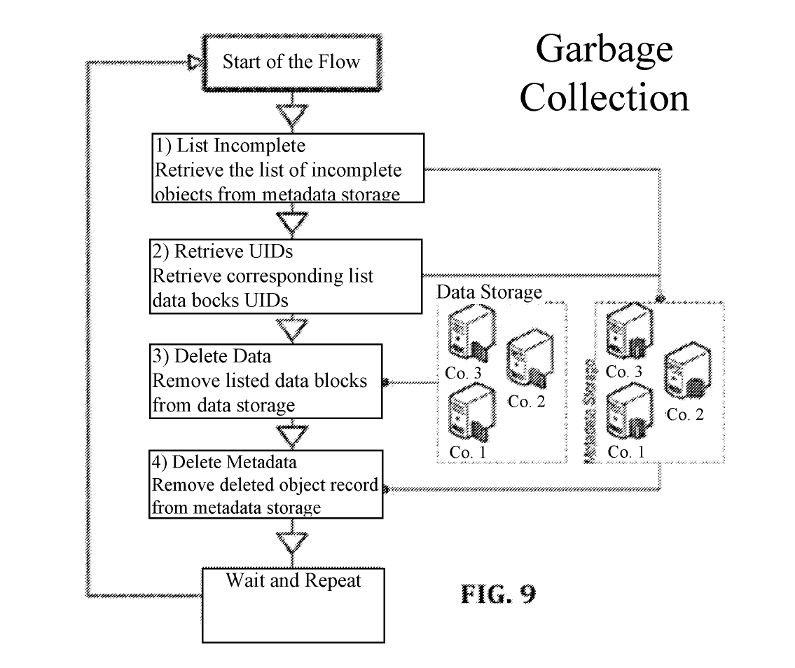

FIG. 9 illustrates the steps of the garbage collection process, which is necessary to delete objects which were stored into storage nodes incompletely, i.e. objects for which mask cardinality is less then k. Such objects may rarely appear in the system if for some reason more than n-k data blocks failed to upload and an application terminated unexpectedly. The flow consists of four steps:
1. List Incomplete: Every fixed period of time (which may be a configurable value) retrieve a list of incomplete objects using LIST INCOMPLETE function of metadata storage.
2. Retrieve UIDs: Retrieve corresponding data blocks UIDs using GET function (see Table 2).
3. Delete Data: Extract storage nodes IDs and data blocks IDs from these UIDs and delete corresponding data blocks from storage nodes using DELETE function (see Table 1)
4. Delete Metadata: Remove deleted object record from metadata storage using DELETE function

Data Dispersal

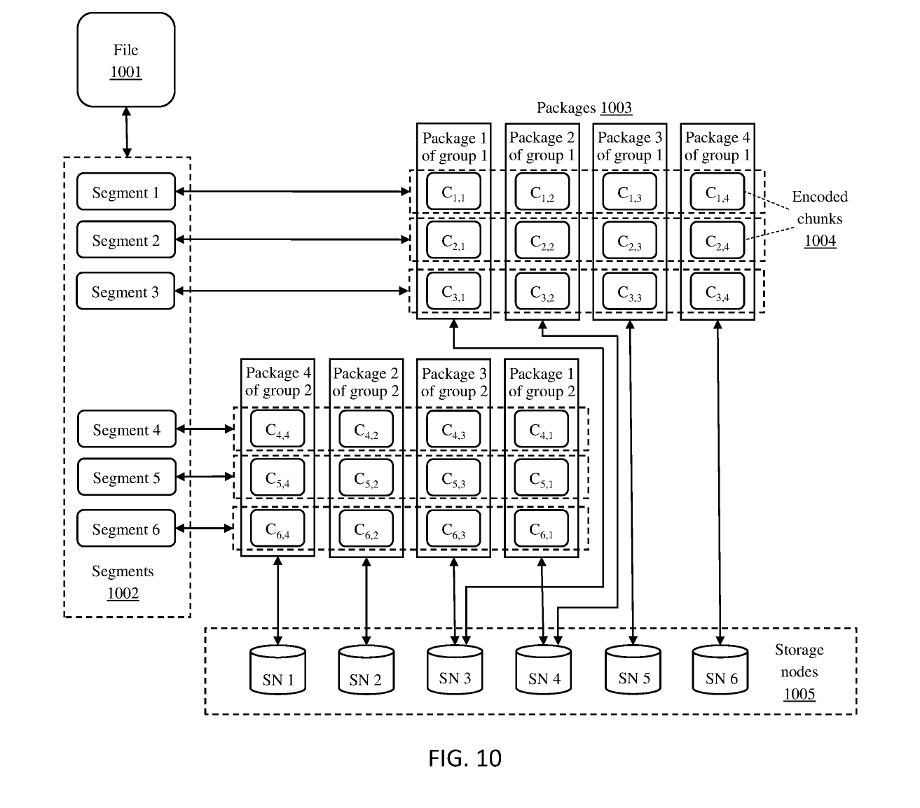

FIG. 10 is a schematic block diagram illustrating file processing and dispersal among storage nodes 1005 for further streaming. Multimedia file 1001 is divided into segments 1002 in such a way that segments are utilized by a player in sequential order during playback. Thus, playback starts as soon as metadata and a small amount of multimedia data have been downloaded, where metadata, e.g. manifest file or map, specifies process of reconstruction of original multimedia file from segments. Segment size is optimized to ensure seamless playback. For a video file segments size corresponds to several seconds of video, e.g. 10 seconds.

Each segment is separately processed and encoded. Encoding comprises at least erasure coding. Such functions as compression and encryption are optional. Erasure coding of a segments is performed using maximum distance separable (MDS) error-correction code, e.g. Reed-Solomon code, or any other code with MDS property. Observe that there are codes such as minimum storage regenerating codes, which are not linear codes, but possess MDS property. MDS property for a code of length n and dimension k presumes that original data (k symbols) may be reconstructed from any k codeword symbols, so that erasure of any n-k symbols are tolerated. In case of Reed-Solomon code arithmetic operations are performed over Galois field. The most commonly used Galois field is GF(2⁸), so that code length is limited by 255 or by 256 for extended Reed-Solomon code. The present invention is intended for a storage system with moderate number of storage nodes, so the number of storage nodes is assumed to be much smaller than 256.

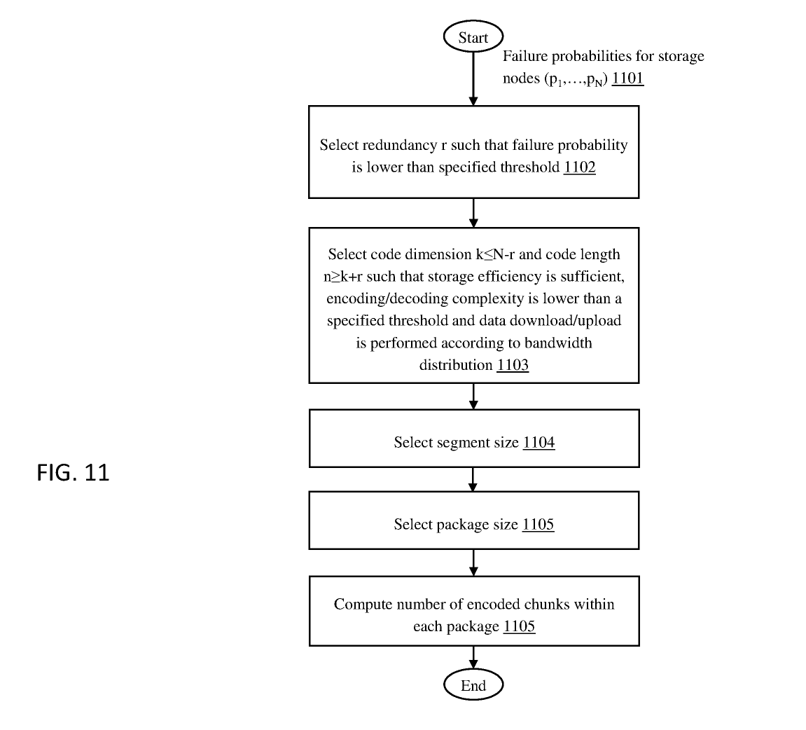

FIG. 11 is a schematic block diagram illustrating selection of code parameters for erasure coding. Redundancy is selected depending on the reliability requirements at step 1102, e.g. the number of tolerated storage nodes failures or failure probability threshold. Code length and dimension are selected at step 1103 depending on the number of storage nodes, reliability requirements, bandwidth of utilized communication channels and multimedia playback requirements. Such requirements also impose limits on acceptable computational complexity. Code length n defines the number of encoded chunks generated from each segment and code dimension k defines the number of encoded chunks required for reconstruction of the segment. Encoded chunks for a segment are stored on different storage nodes located in different areas. Dimension k is optimized to enable seamless playback of a multimedia file. For example, minimize stalling for video on demand and minimize latency for live video. Value of k is sufficiently large to achieve high download speed, while it is limited to keep computational complexity for segments reconstruction at moderate level and satisfies k≤N−r, where N is the number of storage nodes and r is required number of tolerated storage node failures. Code length n satisfies n≤k+r. In most cases n=k+r is selected. However, if there are one or several storage nodes being able to provide much higher download speed compared to other storage nodes, then n>k+r may be selected in order to improve overall streaming speed for clients. In this case additional a=n−(k+r) encoded chunks are dispersed among the most available storage nodes. Code length n is not limited by the number of storage nodes N, thus in some cases n>N leads to increasing download speed. Observe that high download speed is crucial for data streaming applications, while small decrease in storage efficiency is acceptable.

Erasure coding is employed to provide opportunity for data recovery in case of data loss and data corruption. Erasure coding utilizing data mixer algorithm was described above. Security requirements vary for different applications. For example, high security degree is required for medical data storage, while low security degree is acceptable for video streaming. Encoding using data mixer algorithm adjusts security, but increases computational complexity of both encoding and decoding compared to the case of systematic encoding. Low decoding complexity is crucial for streaming applications in case of limited CPU resources. Thus, according to the present invention, erasure coding is implemented using Data Mixer Algorithm or systematic encoding in case of media streaming applications.

Encoded chunks 1004 are encapsulated into packages 1003. Each package comprises one or several encoded chunks with the same indices, i.e. identical positions within codeword. Thus, the same mapping is employed for reconstruction of segments dispersed among the same group of packages, where the number of packages in a group is equal to the code length n. The size of each encoded chunk is defined by the segment size and parameters of employed error-correction code. The package size, i.e. the number of encoded chunks 1004 within each package 1003, is optimized in order to achieve tradeoff between load balancing degree and amount of metadata required for a multimedia file reconstruction. Smaller package sizes provide opportunity for more precise adaptation to available network bandwidth. On the other hand, complexity of logic is simplified with large packages. According to one implementation, operation of partial download of a package is possible, while packages are stored as objects. For example, such storage services as Amazon S3 (Simple Storage Service) provide opportunity for partial read of an object. Thus, in order to reconstruct a particular segment it is not necessary to perform complete download of k packages, it is sufficient to download one encoded chunk from each of k packages together with associated metadata.

Dispersal of packages among storage nodes is further considered. Packages 1004 are assigned to storage nodes 1005 in such a way that predicted download speed is maximized and stalling/latency is minimized. Let N be the number of storage nodes and each group consists of n packets. Let z be the number of packets generated for a multimedia file and Ai be relative amount of data to be placed on i-th storage node, where 0≤Ai>1 and

$${\sum }_{i = 1}^{N} {A}_{i} = 1.$$

Values of Ai are computed depending on available bandwidth, predicted traffic, price policy of storage service provider and etc. Then approximately Aᵢ.z packets will be transferred to i-th storage node, 1≤i≤N. Such data distribution facilitates retrieval of a file from storage nodes. In case of streaming applications, segments are assumed to be reconstructed sequentially to enable playback, so ratio between amounts of data transferred to different storage nodes is also maintained (according to A₁, . . . , A_{N}) for packages generated from any number of subsequent segments.

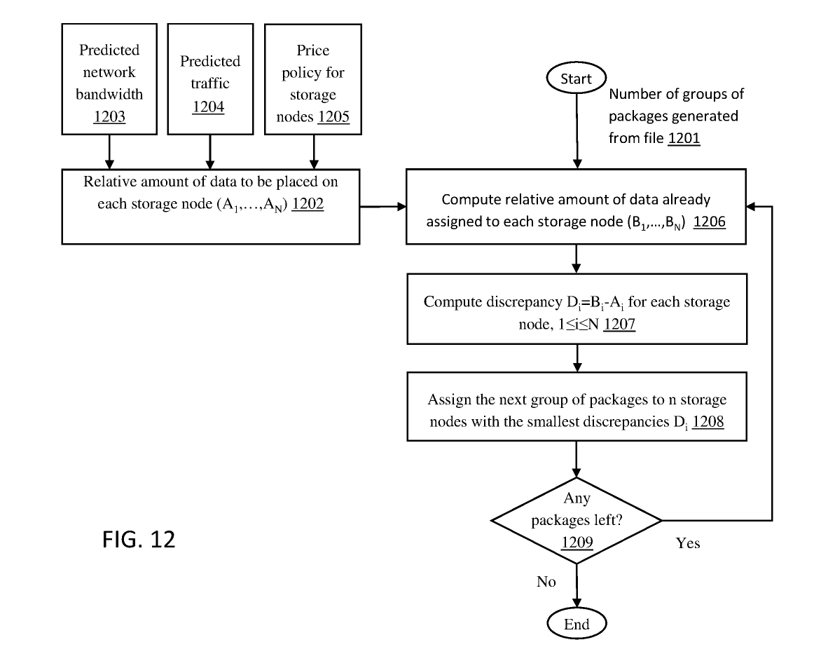

FIG. 12 is a schematic block diagram illustrating example implementation of assigning packages to storage nodes. This implementation is a version of greedy algorithm. Thus, groups of packets are processed sequentially according to their indices and an optimal solution is found for each subsequent group. Computation of relative amount of data to be placed on each storage node (A₁, . . . , A_{N}) at step 1203 is performed prior to file processing, where relative amount of data stored on a storage node is amount of data stored on this storage node divided by the total amount of data stored on all storage nodes. Values (A₁, . . . , A_{N}) are computed only once and then employed for a variety of files. Selection of n storage nodes for a group of n packets requires to perform steps 1204-1206. Packages within the same group are treated equally. Relative amount of data Bi already assigned to i-th storage node is computed at step 1204, 1≤i≤N, then discrepancies between actual and planned values are computed at step 1205. Finally, the next group of n packages is assigned to storages nodes with the smallest values of discrepancies Dᵢ at step 1206. Such choice of storage nodes leads to the same result as minimizing mean-squared error.

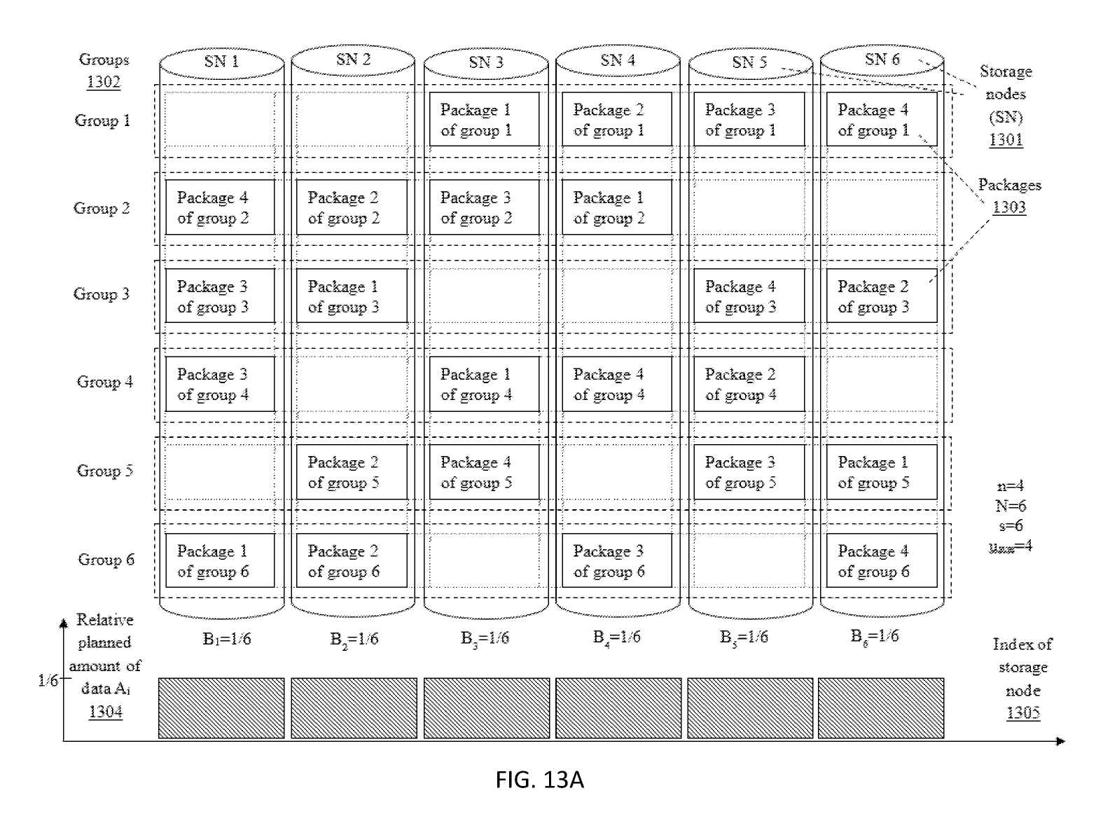

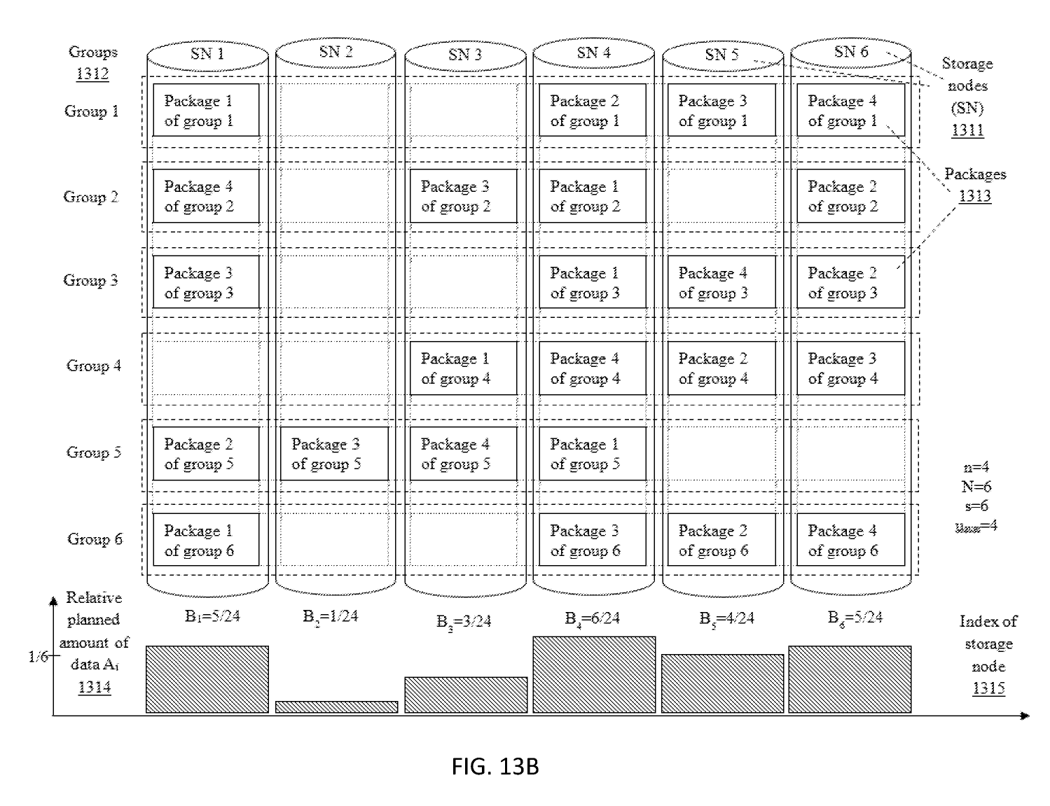

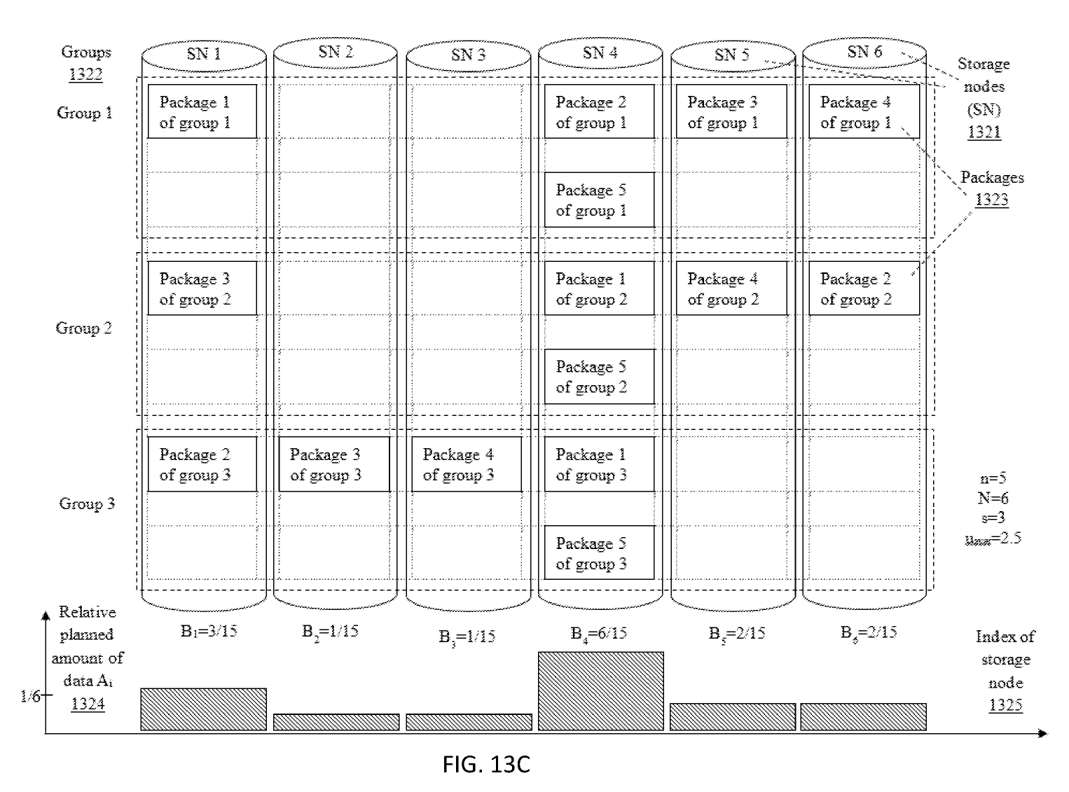

FIGS. 13 (A-C) illustrate possible distribution of amount of data among storage nodes. According to the present invention, upload requires in average transferring of uₐᵥₑᵣ=s·n/N packets to each storage node and download operation requires in average transferring of dₐᵥₑᵣ=s·k/N packets from each storage nodes, where s is the number of groups of packets. Download and upload time depends on the number of packets transferred to/from each storage node. Thus, in case of n=N one obtains uₐᵥₑᵣ=S and dₐᵥₑᵣ=s·k/n, so increasing N provides significant reduction of upload and download time, which is crucial for streaming application. Moreover, observed gain is much more significant compared to the case of streaming from one storage node. In FIG. 13 (A) data is equally distributed among storage nodes, where 6 groups of 4 packages are assigned to 6 storage nodes. Thus, the total number of packages is 24 and 4 packages are assigned to each of 6 storage nodes. Based on distribution of available resources, e.g. network bandwidth, relative planned amount of data Aᵢ for storage nodes is computed, 1≤i≤N, and represented by shaded rectangles, and data is assigned to storage nodes according to this distribution.

FIG. 13(B) illustrates the case of uneven distribution of relative planned amount of data Aᵢ for storage nodes, 1≤i≤N. So, data is unevenly distributed and relative amount of assigned packages Bᵢ is computed for each storage node, 1≤i≤N. In this case uneven data distribution leads to higher upload and download speed.

In FIG. 13(A) and (B) n packages from the same group are transferred to n different storage nodes. If actual redundancy is higher than sufficient, then several packages from the same group may be placed in the same storage node, this case is illustrated by FIG. 13(C). It is reasonable to use such approach, if high download speed is very important and one or several storage nodes are highly available, so that it is faster to download two packages from one storage node than one package from another storage node. In example represented at FIG. 13(C), one storage node has network connection with bandwidth three times higher than other nodes in average, so one additional 5-th package is generated for each of 3 groups, this additional package is further transferred to this highly available storage node (storage node with index 4). Thus, balance between download speed and storage efficiency may be obtained for each particular application. Additional packages are generated in the same way as other packages, more precisely, length of the error correction code is just increased by the number of additional packages.

Data Reconstruction

Process of streaming of a multimedia file starts upon receiving client's request, e.g. in case of video on demand, or according to schedule, e.g. in case of live TV. At first client receives a manifest file, which contains references for all necessary packages and describes how to reconstruct (playback) the file from these packages. Recall that packages are divided into groups and an index is assigned to each group, where indexes are such that sequential processing of groups of packages according to their indices enables playback of the multimedia file. Each group consists of n packages containing the same segments in encoded (dispersed) form. In order to reconstruct original data it is sufficient to download any k packages from each group. According to the present invention, the number of storage nodes N is higher than k, and packages from several groups are transferred from different storage nodes in parallel in order to increase download speed (without increasing latency or stalling). Thus, higher download speed is achieved compared to the case of sequential downloading of groups of packages and sequential segment reconstruction. Thus, the present invention provides increased download speed by fully utilizing available bandwidth of network connections for all storage nodes. Parallel transferring of packages from several groups is implemented using sliding window approach. Sliding window is a sub-list of packages being transferred in current moment from storage nodes to the client. Size of the sliding window is equal to the number of packages within it. For example, if size of sliding window is equal to N, then N packages are transferred from storage nodes in parallel. Packages within sliding window may be transferred from different storage nodes, as well as from the same storage node. As soon as download of a package is complete, a new package with the highest priority is appended to sliding window, while the recently downloaded package is excluded from the sliding window.

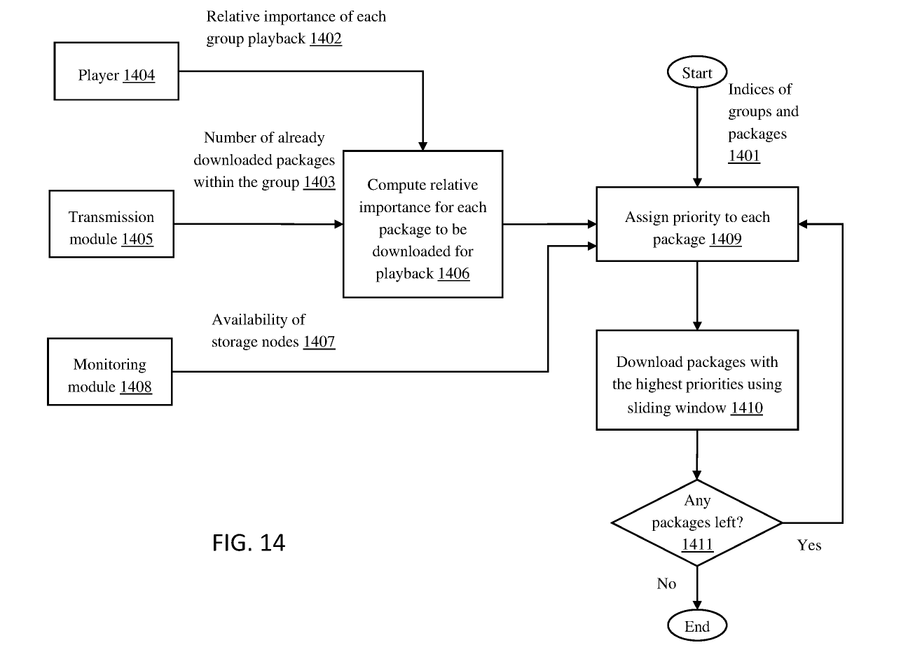

FIG. 14 illustrated process of computation priorities for packages and their downloading. Priority is assigned to each package at step 1409 depending on availability of the storage node 1407 containing this package and relative importance of this package for playback 1406. Relative importance of package to be downloaded for playback 1406 depends on the number of already downloaded packages from this group 1403, which is provided by the transmission module of the system 1405, and relative importance of corresponding group for playback 1402, which depends on current state of the player 1404. Package priority 1409 may be changed at any moment, e.g. during downloading process, because of network bandwidth fluctuations observed by monitoring module 1408. Thus, if low download speed for one package is observed, relative importance of other packages in the same group is increased, e.g. the one with the highest priority among not yet processed by sliding window.

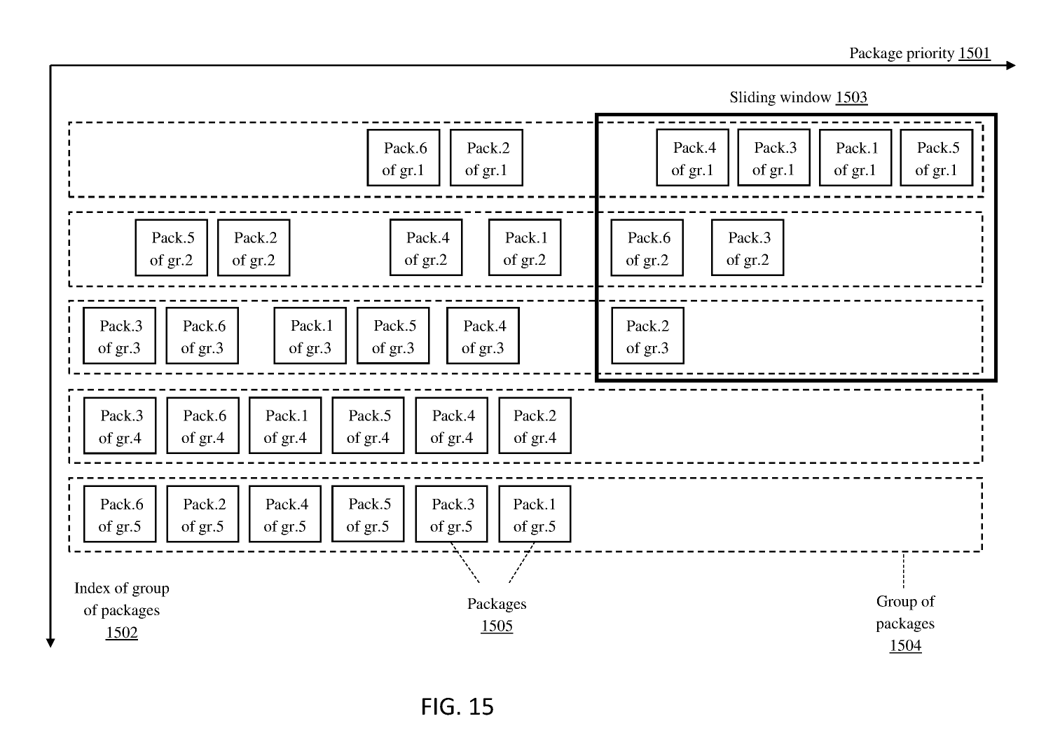

FIG. 15 illustrates usage of sliding window approach for package downloading according to priorities. Sliding window 1503 may have fixed or variable size. In case of fixed size, sliding window contains specified number of packages 1505 with the highest priorities 1501. In case of variable size, sliding window contains packets with priorities higher than a specified threshold. Here index of group of packages 1502 coincide with playback order. The number of package groups being processed simultaneously, i.e. being inside the siding window, is limited by the buffer size. More precisely, buffer should be able to keep at least k packages for each group being processed. Moreover, additional buffer space if required for reconstruction of segments from packages.

Process of multimedia file reconstruction comprises reconstruction of segments from received packages and their merging. These steps are performed according to manifest file (file map). Merging of segments is inverse operation to the splitting of segments described above. Segments are recovered from packages as result of decoding in specified error-correction code. An example implementation of decoder for the case Reed-Solomon codes was described above. Subsequent decryption and/or decompression of data may be required depending on encoding settings, which are specified in the manifest file.

Mesh Network and Network Coding

The description above is related to client-server communication. In case of such applications as live TV there are many clients, who download the same content simultaneously. So, increase in average download speed may be achieved by utilizing peer-to-peer communication.

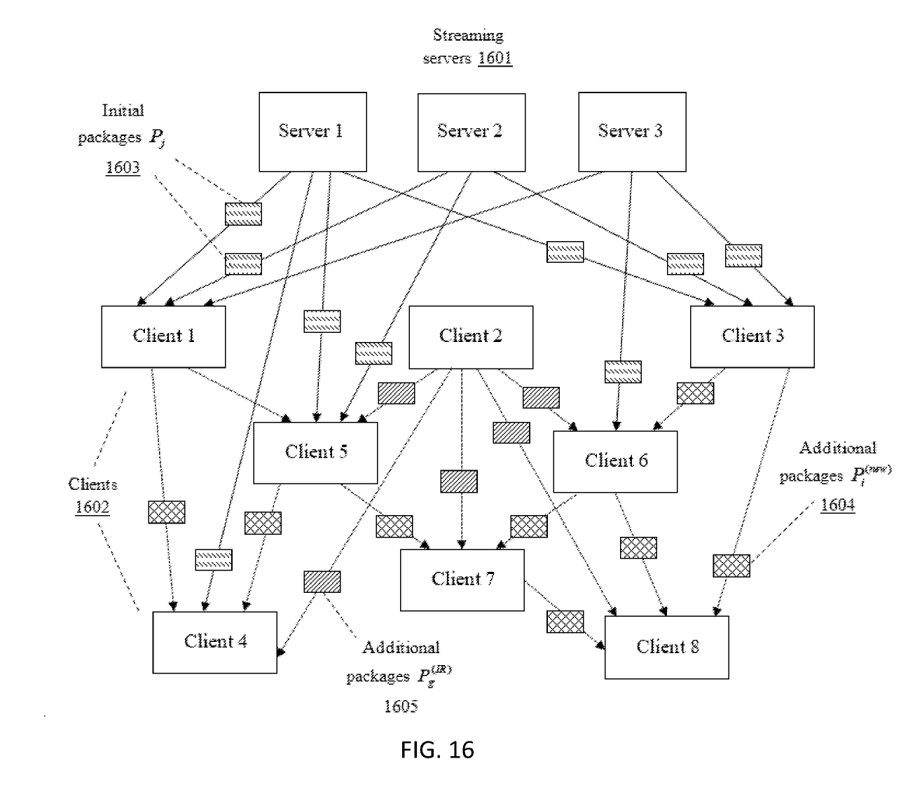

According to the present invention, mesh network is utilized to achieve increase in average download speed in case of streaming of the same content for many clients. So, a client may transfer packages with encapsulated encoded chunks to other clients. The main advantage of mesh network compared to simple peer-to-peer network is dynamic adaptation to changes in network topology. Moreover, mesh network increases resiliency and reduces control of internet service provider (ISP). Furthermore, according to the present invention, network coding is employed on top of mesh network in order optimize network usage for certain applications. FIG. 16 illustrates utilizing mesh network with network coding for data streaming. A client 1602 may transfer to other clients packages provided by the streaming server 1601, as well as new packages generated by himself. A package generated by a client is computed based on earlier received packages. In most cases linear network coding is employed, so a new packagePᵢ^{(new)} 1604 generated by a client is a linear combination of earlier received packages Pⱼ 1603, i.e.

$${P}_{i}^{( new )} = {\sum }_{j = 1}^{t} {β}_{i , j} {P}_{j} ,$$

where β_{i,j} are coefficients depending on selected network coding technique. These new packages are employed to other clients in order to reconstruct original content. Generation of additional packages increases variety of packages within mesh network, thus it reduces probability that a client will receive the same packages from other clients. According to the present invention these is a special type of additional packages P_{g}^{(IR)} 1605, which are processed during decoding in the same way as initial packages. These packages P_{g}^{(IR)} are referred as packages for incremental redundancy (IR), since encapsulated encoded chunks are generated using error-correction code (utilized for encoding of original content) with increased code length. The method of P_{g}^{(IR)} package computation is similar of IR hybrid automatic repeat request (IR-HARQ) scheme. Encoded chunks encapsulated into any additional package P_{g}^{(IR)} are encoded chunks of the error-correction code with increased length. Recall that a client is able to reconstruct original data as soon as the total number of different received/retrieved initial packages Pⱼ and additional packages P_{g}^{(IR)} is equal to k.

According to one implementation, Reed-Solomon codes are employed as error-correction codes for segment encoding. Network coding in case of Reed-Solomon codes is further described in more details. Length of Reed-Solomon code is limited by the number Q of elements in employed Galois field. The most commonly used Galois field is GF(2⁸), which contains Q=256 elements. Reed-Solomon code is specified by its generator matrix, e.g. based on Cauchy or Vandermonde matrix. Construction of Reed-Solomon code provides opportunity to obtain generator matrix for (n+s,k) Reed-Solomon code from generator matrix of (n,k) Reed-Solomon code by appending s columns. Here notation (n,k) is employed for an error-correction code of length n and dimension k. Thus, it is possible to generate up to sₘₐₓ=256-n additional encoded chunks for incremental redundancy, where n is initial code length. A client is able to compute additional packages P_{g}^{(IR)} and transfer them to other clients as soon as he receives k different packages, but till that moment the client can only transfer already received packages. In FIG. 16 client 2 already received all data from streaming servers and sends P_{g}^{(IR)} packages to other clients.

Applications

Migration of Enterprise Data from Company Data Centers into the Cloud

The greatly enhanced data transfer speed, security, reliability and availability of the disclosed technology allows an enterprise to migrate much of its data, including in particular its streaming media content out of their company data centers into the cloud. This will make the company's data available to a far wider range of data consumers both inside and outside the company.

The disclosed technology permits data storage resources throughout the enterprise which are currently under-utilized will then become available for use as secure storage nodes. This can greatly reduce enterprise storage costs, and allow secure distributed storage networks to proliferate throughout the data structure.

Ultimately, this same use of under-utilized data storage resources can find its way into the general population of computer owners with their collections of underutilized storage devices. Vast distributed storage networks can be assembled which will take the older concept behind BitTorrent and supercharge it by adding vastly improved speed and security. The entire mobile device revolution in computer technology is predicated on the availability of data in the cloud. In previous systems, this need has been a weak link in these interlinked technologies, due to the lack of speed and security in cloud storage resources. This is particularly needed now that more private and enterprise clients are accessing data through mobile devices, in particular for streaming media applications. With the face of computer usage headed toward heavy use of mobile devices at the expense of desktops and less mobile laptops, the availability of data to users requires extensive migration of data into the cloud. The disclosed technology aids in making this migration possible.

Digital Media Streaming

The disclosed technology is a natural fit with the needs of digital media streaming technology. The disclosed improvements in speed and security, and greater utilization of available storage resources enables higher streaming rates using today's communications protocols and technologies. The vast amount of storage space required for storage of video, audio and other metadata can further benefit from increased availability and utilization of existing resources and infrastructure, in accordance with the exemplary embodiments disclosed herein.

Satellite TV

The large hard drives built into satellite TV technology provide an example of how an under-utilized storage resource can be adapted to use the disclosed technology to establish a fast, secure distributed storage network among the general public of satellite TV users. This resource can greatly enhance the value of the satellite TV network, and open up entirely new commercial opportunities.

In certain embodiments according to the present disclosure, a highly secure erasure coding algorithm is used to code file fragments to provide for data recovery in case some data is lost due to errors in the transmission process.

In particular, a Data Mixer Algorithm (DMA) is employed that encodes an object F of size L=|F| into n unrecognizable pieces F₁, F₂, . . . Fₙ, each of size L/m(m<n), so that the original object F can be reconstructed from any rn pieces. The core of the DMA is an m-of-n mixer code. Data in the fragments processed with the DMA is confidential, meaning that no data in the original object F can be reconstructed explicitly from fewer than m pieces. An exemplary embodiment of the detailed operation of the DMA will now be described.

The m-of-n mixer code is a forward error correcting code (FEC), whose output does not contain any input symbols and which transforms a message of m symbols into a longer message of n symbols, such that the original message can be recovered from a subset of the n symbols of length m.

The original object F is firstly divided into m segments S₁, S₂ . . . Sₘ, each of size L/m. Then, the m segments are encoded into n unrecognizable pieces F₁, F₂, . . . Fₙ using a m-of-n mixer code, e.g.:

(S₁, S₂, . . . Sₘ)·G_{m×n}=(F₁, F₂, . . . Fₙ),

where G_{m×n} is a generator matrix of the mixer code and meets the following conditions:

1) Any column of G_{m×n} is not equal to any column of an rn x rn identity matrix

2) Any m columns of G_{m×n} form an m×m nonsingular matrix

3) Any square submatrix of its generator matrix G_{m×n} is nonsingular

The first condition ensures that the coding results in n unrecognizable pieces. The second condition ensures that the original object F can be reconstructed from any m pieces where m<n and the third condition ensures that the DMA has strong confidentiality.

An effective way to construct a DMA with strong confidentiality from an arbitrary m-of-(m+n) mixer code is:

1) Choose an arbitrary m-of-(m+n) mixer code, whose generator matrix is

G_{m×(m+n)}=(C_{m×m}|D_{m×n)}

2) Construct a DMA that adopts an m-of-n mixer code whose generator matrix is

C⁻¹_{m×m}·D_{m×n}

For example, the generator matrix may be a Cauchy matrix shown below.

Any square submatrix of a Cauchy matrix,

$${G}_{C} = ( \begin{matrix}\frac{1}{{x}_{1} + {y}_{1}} & \frac{1}{{x}_{1} + {y}_{2}} & … & \frac{1}{{x}_{1} + {y}_{m}} \\ \frac{1}{{x}_{2} + {y}_{1}} & \frac{1}{{x}_{2} + {y}_{2}} & … & \frac{1}{{x}_{2} + {y}_{m}} \\ ⋮ & ⋮ & ⋱ & ⋮ \\ \frac{1}{{x}_{n} + {y}_{1}} & \frac{1}{{x}_{n} + {y}_{2}} & … & \frac{1}{{x}_{n} + {y}_{m}}\end{matrix} ) ,$$

where x₁, . . . , xₙ, y₁, . . . , yₙ ϵ Zₚ, xᵢ+yᵢ≠0; i≠j=>xᵢ≠xⱼ and yᵢ≠yⱼ is nonsingular. Thus, a mixer code based on this matrix has strong confidentiality.

As another example, the generator code can be a Vandermonde matrix.

To construct a DMA with strong confidentiality from a mixer code whose generator matrix is a Vandermonde matrix, choose a m-of-(m+n) mixer code with generator matrix

$${G}_{V} = ( \begin{matrix}{a}_{1}^{0} & {a}_{2}^{0} & … & {a}_{m + n}^{0} \\ {a}_{1}^{1} & {a}_{2}^{1} & … & {a}_{m + n}^{1} \\ ⋮ & ⋮ & ⋱ & ⋮ \\ {a}_{1}^{m - 1} & {a}_{2}^{m - 1} & … & {a}_{m + n}^{m - 1}\end{matrix} ) ,$$

where a₁, a₂, . . . aₘ₊ₙ are distinct.

Then, a DMA with strong confidentiality can be reconstructed, in which the corresponding generator matrix is

$${G}_{IDMA} = {( \begin{matrix}{a}_{1}^{0} & {a}_{2}^{0} & … & {a}_{m}^{0} \\ {a}_{1}^{1} & {a}_{2}^{1} & … & {a}_{m}^{1} \\ ⋮ & ⋮ & ⋱ & ⋮ \\ {a}_{1}^{m - 1} & {a}_{2}^{m - 1} & … & {a}_{m}^{m - 1}\end{matrix} )}^{- 1} \times ( \begin{matrix}{a}_{m + 1}^{0} & {a}_{m + 2}^{0} & … & {a}_{m + n}^{0} \\ {a}_{m + 1}^{1} & {a}_{m + 2}^{1} & … & {a}_{m + n}^{1} \\ ⋮ & ⋮ & ⋱ & ⋮ \\ {a}_{m + 1}^{m - 1} & {a}_{m + 2}^{m - 1} & … & {a}_{m + n}^{m - 1}\end{matrix} )$$

### ENCODING EXAMPLE

Assume we have an object F of size L=|F|. In the example, L=1 048 576 (1 Mb file). To encode it the following steps are performed:
1. Chose m and n (see description above). For example, m=4, n=6.
2. Chose a word size w (usually 8, 16, 32, which in this example it will be 8). All the arithmetic will be performed over GF(2^{w}).
3. Chose a packet size z (must be a multiple of computer's word size, and in this example it will be 256).
4. Calculate coding block size Z=w·z, which should also be multiple of m. In this example Z=8·256=2048 (bytes) and it is multiple of 4.
5. Pad original object F with random bytes, increasing it size from L to L′ so that L′ is multiple of Z.
6. Split object F into pieces of size Z. All following steps will be performed over these pieces, however we will denote them still by F.
7. Segment F into sequences F=(b₁, . . . bₘ,), (bₘ₊₁, . . . b₂ₘ), . . . where b₁ is a w bits length character. In this example it's just a byte. Denote S₁=(b₁, . . . bₘ,), etc. for convenience.
8. Apply the mixing scheme:

Fᵢ=Ci1, Ci2, . . . , Cin,

where

Cᵢₖ=aᵢ·Sₖ=aₐ₁·b₍ₖ₋₁₎ₘ₊₁+ . . . +aᵢₘ·bₖₘ,

where aᵢⱼ are elements of the n×m Cauchy matrix (see above) Note, that size of Fᵢ is Lᵢ=L/m, in our example this is 250 kb (162 144 bytes)

### DECODING EXAMPLE

Assume now, we have m object pieces Fᵢ of size Lᵢ. In our example, i=1, 3, 5, 6, on the assumption that F₂ and F₄ have been lost due to transmission errors. To decode and reconstruct original object F, we perform the following steps:
1. Construct m x m matrix A from the n×m Cauchy matrix used for encoding by removing all the rows except rows with numbers i. In our example rows 2 and 4 are removed.
2. Invert the matrix A, and apply de-mixing scheme:

$$[ \begin{matrix}{b}_{1} \\ ⋮ \\ {b}_{m}\end{matrix} ] = {A}^{- 1} \cdot [ \begin{matrix}{c}_{11} \\ ⋮ \\ {c}_{m 1}\end{matrix} ]$$

for each segment S₁=(b₁, . . . bₘ,), etc.
3. Join segment Sᵢ into original Z-length piece F.
4. Join Z-length blocks together to form original, padded object F.
5. Remove padding from F, making it fit size L.

In exemplary embodiments, the foregoing methodologies of processing data for distributed storage and erasure encoding that makes the original data unrecognizable, are used to process streaming media content. As explained above, the media file of a content provider is broken up into small file slice fragments in a two-step process. The first step breaks up the whole file (which may be compressed or not compressed) into a series of file slices. These file slices may be encrypted, and a metadata file is created which maps how to assembly the slices into the original file.

The second step takes each file slice and breaks it down into smaller data fragments that are erasure coded in accordance with the foregoing techniques to make the original data unrecognizable. The erasure coding may be performed by a set of high-performance file servers with each separate server conducting erasure coding on its file slice(s). This represents a system of virtual erasure coding distributed across n erasure coding server units. The erasure coding adds a pre-defined level of redundancy to the data collection while creating a series of file slice fragments which are then dispersed to a series of file fragment storage nodes. Optimal redundancy of 30% or higher is desired for the erasure coding used in this process. If the media file is frequently accessed, the system can increase file object redundancy of particular slices.

The erasure coding technique disclosed herein adds a powerful system of automatic error correction which insures that the client receives the correct data packets for the streamed media file, in spite of packet losses. Each data fragment may also be encrypted in the process of erasure coding. A second meta-data file maps the process needed to re-assemble the file slice fragments into the correct streamed media packets. Typically, a minimum of 5 nodes may be needed to successfully process the data for streaming (although the number of nodes is a function of system loading and other parameters). These nodes do not need to be all located near the client who will be receiving the streamed data, but may be located over a wide geographic service area.

To playback the streaming media content, clients download from the server nodes the required data fragments which are then re-assembled in the proper order. The reassembly reverses the process by which the data fragments were created. Data fragments are reassembled into file slices, and file slices are then reassembled into at least portions of the original media file. As in all streaming technology, the rate of download and processing of the data fragments should be fast enough to allow on time processing of the data packet currently needed for playing the media. The client application, which may include any device capable of playing streamed media, retrieves the file slice fragments in the proper order to begin playing the streamed media file.

With streamed media, it is essential that all the data fragments are reassembled sequentially in the proper order, to view or listen to the media from beginning to end. The client device re-assembles the data fragments by using map data from the meta-data files to properly obtain the fragments in their proper sequence. As with current streaming technologies, if the rate of download is faster than the time needed to display the next packets of media data, the reader will download and assemble future time fragments which are stored in a buffer for use when the media player reaches that time segment. The file fragments may not be actually ever assembled into the original media file, but merely played at the proper time, and stored as data fragments. This increases the security of the digital media being played, if the user does not have legal rights to the media file. Of course, if the user does have legal rights to the original media file, the fragments can be assembled on the client's device in the form of the complete original media file, once all the fragments have been downloaded. Because the media file is transmitted from multiple nodes, the file download rates will far exceed the typical rates seen in prior art technology. Preferably, nodes which have at the moment the best connectivity to the client for downloading of data fragments are employed. Since the data on the nodes is redundant, the client software when reading the streamed data may preferentially choose those nodes with the highest rates of data transfer for use in the download.

This technology is applicable to all types of client devices: desktops, laptops, tablets, smartphones, etc. It does not have to replace the current streaming technology software, but can merely add another layer on top of it for using map files to reassemble the required data fragments in the proper order.

Advantages Over Previous Systems

The disclosed distributed storage and erasure coding-based streaming technology offers substantial improvements over the limitations discussed above in prior art streaming technologies.

A. Speed of Data Transfer

For the reasons discussed above, the disclosed embodiments offer substantial improvements in speed of data transfer over typical internet communication conditions compared to prior art streaming technology.

While a media content provider may choose to disperse the data fragments to high performance servers in the cloud, he may also choose to store the data fragments on multiple storage devices connected in any other type of network. When reconstructing the media file the “pieces” may be transferred from/to multiple servers in parallel, resulting in substantial throughput improvements. This can be likened to the popular download accelerator technologies in use today which also open multiple channels to download pieces of a file, resulting in substantial boost in download rates. Latency bottlenecks in one of the transfer connections to one of the node servers will not stop the speedier transfers to the other servers which are operating under conditions of normal latency. The higher speed of data transfer allows for large, uncompressed media files to be played in real time, and thus brings hi-fidelity reproduction to streaming media.

The client side software technology may choose to preferentially download from those nodes offering the highest current throughput for a particular client at his location, resulting in further speed improvements to throughput. From the entire worldwide pool of available nodes, each client application may choose to read from media streams from those nodes which offer the highest throughput at the moment. The redundancy of erasure coding also means that more than one node contains the next needed fragments, allowing the client to choose the highest throughput nodes available.

The dispersal of data fragments to data storage nodes can also be optimized based on the current throughput conditions. Nodes with the best connectivity can be chosen to store larger amounts of data fragments, thus optimizing the storage nodes available for maximum speed of data transfer during the dispersal process.

Specifically, the erasure coding used in the technology may be done at the server side, on servers that have been chosen for high performance, since erasure coding can be a CPU intensive task.

B. Data Security

As discussed above, the distributed and “virtual erasure coding” streaming technique disclosed herein offers vast improvements of data security over prior streaming technology which stores a whole file in a single physical cloud storage location.

Further, the servers used for both processing and storage of file slice fragments may be shared by multiple clients, with no way for a hacker to identify from the slices to which client it belongs. This makes it even more difficult for a hacker to compromise the security of media file data stored using this technology.

C. Data Availability

As discussed above, the distributed storage and “virtual erasure coding” streaming technique disclosed herein also offers improvement in the availability of the data, compared to prior art streaming technology. By splitting the file into multiple file slice fragments which are stored on a number of physical nodes, that preferably are located at different locations, communication problems between the client location and one of the physical nodes may be offset by normal communications with the other data locations. The overall effect of having multiple locations is to insulate the system from outages due to communications disruptions at one of the sites.

The use of erasure coding that makes the original data unrecognizable, and multiple nodes with redundant data adds powerful and secure error correcting technology. Packet loss problems, which plague the prior art streaming technology are no longer a relevant consideration. The prior art streaming technology must often put multiple copies of the same media file on many servers throughout the geographical service area, to make sure that each client has good connectivity to the server that stores the data stream he wishes to play. The disclosed streaming technology eliminates the need for full redundant copies of the original media file on multiple servers throughout the service area.

D. Data Reliability

The distributed storage and “virtual erasure coding” streaming technology disclosed herein also brings vast improvements in reliability of streaming media over the prior art. Separation of each file into file slice fragments means that hardware or software failures or errors at one of the physical server storage locations will not eliminate access to the file, as is the case when the entire file is stored in one physical location, as in the prior art technology. Erasure coding technology for making the original data unrecognizable insures high quality error correction capabilities while enhancing security of the media content.

E. Digital Rights Management Security

The protection of digital rights (DRM) is a particularly important issue with streaming media files. Many third-party products are available which can circumvent DRM protection schemes in streaming media. As the disclosed technology breaks up the data stream into data fragments which may be encrypted and each processed with erasure coding that can make the original data unrecognizable, DRM protection schemes are greatly enhanced. If the client requesting the streaming media does not have rights to the file itself, but only rights to play the file, the encrypted and erasure-coded data fragments do not have to be physically assembled into an actual media file on the client device, even during play. This invites much stronger DRM schemes which cannot be readily circumvented by the usual third party technologies in use today.

To summarize, in an exemplary embodiment, the distributed storage and “virtual erasure coding” streaming technology disclosed herein accomplishes the following fundamental tasks:
1) Splitting of a content provider's media file slice into pieces or file slices which will eventually be broken up further into file fragments that are erasure coded on distributed erasure coding servers to provide unrecognizable pieces.
2) Creation of maps of the file slices which describe how the files were split to allow for re-assembly of the data at the client. This map is stored in a metadata file.
3) Optional encryption of the file slices for additional data security.
   4) Optional compression of the file slices to reduce the size of data storage and improve transfer speed.
   5) Erasure coding of the file slices to enable enhanced error correction and data recovery. The slices are divided into file slice fragments by the erasure coding process.
6) Creation of a map of the file slice fragments needed to reassemble them into file slices. This map is stored in a second metadata file.
7) Optional encryption of the file slice fragments for additional data security.
8) Optional compression of the file slice fragments to reduce storage space requirements and improve transfer speed.
9) Decoding on the client device of the file slice fragments and re-assembly into file slices, and then into the whole media file, for playing on the client media player (or browser). Note that the fragments must be assembled into slices in the proper order, and the slices must be assembled into the whole file in the proper order. The client software uses the mapping information provided by the two metadata files to reassemble the media file in these two stages.

The basic structure of this technology may be visualized as being implemented by the following four layers:

1. The CSP (see, FIG. 1) slices the content provider's media file into file slices, optionally encrypts the slices, and generates a meta-data file with a map of how the slices can be re-assembled into the original media file. The meta-data file also maintains information on the order of each file slice needed to assemble the slices in the proper order.

2. The FEDP (see, FIG. 1) breaks each file slice into file slice fragments using erasure coding that produces unrecognizable pieces. In an exemplary embodiment erasure coding adds 30% of data redundancy. A second meta-data file maps how the file slice fragments are reassembled into to file slices. The second meta-data file also maintains information on the order of each fragment needed to assemble the slices in the proper order, during playing of the fragments on the client device.

3. The SNNs (see, FIG. 1) are the various storage nodes used to disperse the data fragments. The storage nodes are not necessarily all servers in the cloud. The nodes may be a data center, a hard disk in a computer, a mobile device, or some other multimedia device capable of data storage. The number and identity of these storage nodes can be selected by the content provider to optimize the latency and security of the storage configuration with nodes having the lowest average latency and best availability.

4. An end-user client decoder (ECD) that may be implemented on top of current technology streaming media player software. This fourth layer initiates a request to the content provider for streaming media, and then receives mapping files derived from the two meta-data files formed in layers (1) and (2), above which allow the ECD to assemble the file slice fragments into slices, and the slices into the original media file, for the playback or storage of the media file. As evident, the media file must be assembled in the proper order needed for on demand playing of the media content. If the client has purchased rights to the streamed media for downloading the complete file, the ECD will both play and assemble the original media file, once it has completely downloaded. If the client only has rights to play the media file, the ECD will only play the media file in the proper order, while storing the file slice fragments for possible re-play, without ever assembling them into a complete file. The ECD will also buffer the data fragments in storage on the client device if the rate of download exceeds the rate of media play, which should happen most of the time. The ECD may also interact with the media player to receive and process requests for media file segments which are located ahead of or behind the current time of media file play.

Additional Performance Considerations

If the particular media file is in high demand from multiple clients, there are two main approaches that can be taken to meet the increased demand:

First, a larger number of fragment storage nodes may be employed for dispersal of the erasure encoded data fragments. If the demand is primarily coming from one geographic area, nodes could be chosen for dispersal with the best data throughput rates for clients in that area.

Second, a higher level of redundancy may be chosen for the erasure coding step. For example, instead of 30% redundancy, higher levels of redundancy will help ensure greater available under load.

These two steps may be performed dynamically to meet specific demand and load requirements as they occur in real time.

In addition, certain slices or fragments may be singled out for greater levels of redundancy to improve availability. Specifically, the first segments of the media file could should be given the highest level of redundancy to meet the needs of increased demand.

Although the disclosed subject matter has been described and illustrated with respect to certain exemplary embodiments thereof, it should be understood by those skilled in the art that features of the disclosed embodiments can be combined, rearranged, and modified, to produce additional embodiments within the scope of the disclosure, and that various other changes, omissions, and additions may be made therein and thereto, without departing from the spirit and scope of the present invention.

1. A method of processing media content, comprising the steps of:
separating the media content into a plurality of file slices;
generating metadata for the reassembly of media content from the file slices;
erasure coding the file slices, wherein the slices are divided into discrete file slice fragments;
generating metadata for the reassembly of the file slices from the file slice fragments; and
sending the file slice fragments to a plurality of dispersed networked storage nodes, wherefrom the media content may be retrieved and reconstructed using the metadata.

2. The method of claim 1 wherein the media content is not recognizable from the erasure-coded file slice fragments.

3. The method of claim 2 wherein the step of erasure coding is performed across a plurality of data processors.

4. The method of claim 2, further comprising the steps of:
receiving at a client decoder the file slice fragments from the networked storage nodes; and
reconstructing the media content according to the metadata.

5. The method of claim 4 wherein the media content is one of streaming video and audio content, and wherein the step of reconstructing the media content is performed contemporaneously during playback of the media content.

6. The method of claim 5 wherein the steps of receiving and reconstructing are performed in response to a client request for the media content; and/or wherein each file slice fragment is assigned a unique identifier and the metadata indicates the location of each file slice fragment in the plurality of dispersed networked storage nodes based on its unique identifier; and/or wherein the step of erasure coding results in at least a thirty percent data redundancy level.

7. The method of claim 6, third alternative, wherein the number and identify of the storage nodes are selected by a content provider to reduce the latency of the storage node network.

8. The method of claim 1 wherein the storage nodes are located in physically separated devices.

9. The method of claim 8 wherein the physically separated devices are geographically dispersed.

10. The method of claim 1 wherein no one storage node has sufficient information to allow reconstruction of the media content.

11. A method of receiving media content, comprising the steps of:
requesting media content stored across a plurality of dispersed networked storage nodes as erasure-coded file slice fragments;
receiving at a client decoder the erasure-coded file slice fragments and metadata containing information for reconstruction of the media content from the file slice fragments; and
reconstructing the media content at the client decoder from the file slice fragments based on the metadata.

12. The method of claim 11 wherein the media content is one of streaming video and audio content.

13. The method of claim 12 wherein the media content is unrecognizable from the file slice fragments.

14. The method of claim 11 wherein each file slice fragment is assigned a unique identifier that indicates the location of the file slice fragment in the plurality of dispersed networked storage nodes; and/or wherein the number and identify of the storage nodes are selected by a content provider to reduce the latency of the storage node network.

15. (canceled)

16. A method for distributed processing and storage of data, comprising the steps of:
dividing a data file into a plurality of file slices;
providing a plurality of data processors for receiving the file slices, each data processor erasure coding at least one of the file slices to generate a plurality of unrecognizable file slice fragments;
storing the file slice fragments in a network of storage nodes, wherein no one storage node has sufficient information to allow reconstruction of the data file.

17. The method of claim 16 wherein the step of erasure coding divides a file slice having m segments into a plurality of n unrecognizable file slice fragments, where n>m, by using a data mixer algorithm that permits reconstruction of the n file slice fragments from any m file slice fragments.

18. The method of claim 17 wherein the data mixer algorithm uses a Cauchy matrix as a generator matrix; or wherein the data mixer algorithm uses a Vandermonde matrix as a generator matrix.

19. The method of claim 5 wherein the steps of receiving and reconstructing are performed in response to a client request for the media content.

20. The method of claim 5 wherein each file slice fragment is assigned a unique identifier and the metadata indicates the location of each file slice fragment in the plurality of dispersed networked storage nodes based on its unique identifier.

21-29. (canceled)
